(19) United States
(12) Patent Application Publication
(10) Pub. No.: US 2021/0019979 A1
(43) Pub. Date: Jan. 21, 2021

(54) KEY TRANSFER SYSTEM AND METHOD WITH INDEPENDENTLY ACCESSIBLE STORAGE UNITS

(71) Applicant: STORM KIOSKS INC., Calgary (CA)

(72) Inventors: Darrell Nathan Mackenzie, Calgary (CA); Simon Paul House, Calgary (CA)

(21) Appl. No.: 16/875,175

(22) Filed: May 15, 2020

(30) Foreign Application Priority Data
Jul. 16, 2019 (CA) 3049765
Jan. 29, 2020 (CA) 3070187

(51) Int. Cl. G07F 17/12; G07F 17/42; G07F 9/00

(52) U.S. Cl. CPC G07F 17/12; G07F 17/42; G07F 9/009; G07F 9/006; G07F 9/001

(57) ABSTRACT

Described are various embodiments of a system for releasably storing keys to a vehicle, the system comprising a plurality of independently accessible storage units, each said independently accessible storage unit configured to be unlocked independently of one another based on digital unlocking signals that trigger unit-specific lock mechanisms; a communications bus for interfacing with a pre-existing independent third-party data storage facility; one or more user interface devices for receiving user-identifying information about users; local digital data storage for storing locally-stored information relating to one or more of the following: user-identifying information, keys, storage units; a processor, being communicatively coupled to said local digital data storage, said communications bus, and said multi-unit storage facility, said processor configured determine whether a given user is authorized to access a given storage unit based on said user-identifying information and transmit a digital unlocking signal to the given storage unit when the requesting user is determined to be authorized to access the given storage unit.

### RELATED APPLICATION

The present application claims benefit of priority to Canadian Patent Application serial number: 3,049,765, filed Jul. 16, 2019 and entitled “KEY TRANSFER SYSTEM AND METHOD WITH INDEPENDENTLY ACCESSIBLE STORAGE UNITS”.

### FIELD OF THE DISCLOSURE

The present disclosure relates to key transfer systems and methods for independently accessible storage units, and, in particular, to their application in association with the transfer of control of keys for cars, houses, and other user entities, particularly for the purposes of having services performed in association with such user entities.

### BACKGROUND

This background information is provided to reveal information believed by the applicant to be of possible relevance. No admission is necessarily intended, nor should be construed, that any of the preceding information constitutes prior art or forms part of the general common knowledge in the relevant art.

Currently, the transfer of keys for vehicles from the vehicle owner to a third-party service provider, such as a vehicle service centre, can be an inconvenient process for both vehicle owners as well as the service providers. For vehicle owners, it requires bringing vehicles to service providers' locations at inconvenient times. Vehicle owners typically avoid the inconvenience and discomfort of dealing with a sales person. Service providers require dedicated staff for intake of vehicles and transfer of keys.

Typical key transfer systems are limited to keys and do not support the transfer of other related or ancillary materials that may be transferred concurrently with keys. Moreover, security and reliability issues are experienced by systems that use a common key transfer system (i.e. a commonly accessible key repository location that deposits or otherwise renders accessible keys into a single common location).

Many current key transfer systems typically use a “vending machine” format, such as the one disclosed in U.S. patent application Ser. No. 15/451,060, to Marcelle et al. which are prone to failure as they use a common system to move keys from the receiving location to the storage location, and from the storage location to the dispensing location. Moreover, only keys can be transferred.

Other issues relate to the inability of current systems to communicate with third-party information repositories used for the processing of services and services-related information to the vehicle (or other lockable unit owned by the owner). Real-time information relating to the vehicle, the status of the services, warranty information, financial information, driver preferences, and historical information may provide significant information that is either required or would be highly convenient to use or to provide to vehicle-owners at the time of key transfer. An example of such information repository would include a dealer management system that is used to track vehicle service information (including status and payment information), warranty information, and vehicle and owner historical information. This information, which is either required at the point of transfer of keys or would provide significant opportunity to increase convenience, reduce interaction time, and increase the availability of value-add services, is unavailable in key transfer circumstances with having a person to identify and look for it.

### SUMMARY

The following presents a simplified summary of the general inventive concept(s) described herein to provide a basic understanding of some aspects of the subject matter described herein. This summary is not an extensive overview of the invention(s) described herein. It is not intended to restrict key or critical elements or to delineate the scope of the subject matter described herein beyond that which is explicitly or implicitly described by the following description and claims.

A need exists for key transfer system and method with independently accessible storage units that overcome some of the drawbacks of known techniques, or at least, provides a useful alternative thereto. Some aspects of this disclosure provide examples of such key transfer systems.

In accordance with one aspect, there is provided a system for releasably storing keys, the keys providing access for a keyholder to a lockable user entity, the system comprising a multi-unit key storage facility comprising a plurality of independently accessible storage units, each said independently accessible storage unit configured to be unlocked independently of one another based on digital unlocking signals that trigger unit-specific lock mechanisms; a communications bus for interfacing with a pre-existing independent third-party data storage facility, the third-party data storage facility comprising pre-existing service information relating to: the lockable user entity, a user thereof, or a combination thereof; one or more user interface devices for receiving user-identifying information about users; local digital data storage for storing locally-stored information comprising: user-identifying information and authorization information relating to each independently accessible storage unit; a processor, being communicatively coupled to said local digital data storage, said communications bus, and said multi-unit storage facility, said processor configured determine whether a given user is authorized to access a given storage unit based on said user-identifying information and said authorization information, said processor further configured to transmit a digital unlocking signal to the given storage unit when the requesting user is determined by said processor to be authorized to access the given storage unit.

In accordance with another aspect, there is provided a method for securely transferring keys for vehicles associated with remotely-stored independent third-party vehicle information, using a multi-unit key storage device with a plurality of independently accessible key storage units, each said key storage unit comprising a locking mechanism configured to be unlocked upon receipt of a digital unlocking signal, the method comprising the steps: interfacing, via a communications bus, a pre-existing independent third-party data storage facility, and obtaining pre-existing vehicle-specific information, said vehicle-specific information comprising vehicle information, vehicle owner information, and vehicle service event information from said third-party data storage facility; receiving, via one or more user interface devices, user-identifying information relating to a user, said user being one of the following: a vehicle owner associated with the given vehicle, a service-provider associated with the given vehicle; allocating a key storage unit from the plurality thereof for storing a given vehicle-specific key associated with a given vehicle having vehicle information associated therewith stored in the data storage facility relating to one or more service events for said given vehicle; transmitting the digital unlocking signal to the first key storage unit allocated for the vehicle-specific key upon receipt by the key storage device of user-identifying information associated with said vehicle-specific key, and one or more of the following from said third-party data storage facility: scheduling information associated with said given vehicle, completion information relating to said vehicle service event, payment information associated with said vehicle service event.

In accordance with another aspect, there is provided a method for securely transferring virtual keys for vehicles associated with remotely-stored independent third-party vehicle information, using a key storage distribution server, having a key distribution processor and a key distribution storage resource, the method comprising the steps: interfacing end-user devices, via a communications bus at the key storage distribution server, a pre-existing independent third-party data storage facility, and obtaining pre-existing vehicle-specific information, said vehicle-specific information comprising vehicle information, vehicle owner information, and vehicle service event information from said third-party data storage facility; receiving, via a given end-user device, user-identifying information relating to a user, said user being one of the following: a vehicle owner associated with the given vehicle, a service-provider associated with the given vehicle; allocating a logical key storage slot in the key distribution storage resource for uniquely associating a given virtual key and a given vehicle having vehicle information associated therewith stored in the data storage facility relating to one or more service events for said given vehicle; and transmitting the given virtual key to a requesting user upon receipt by the key storage device of user-identifying information associated with the given virtual key, and one or more of the following from said third-party data storage facility: scheduling information associated with said given vehicle, completion information relating to said vehicle service event, payment information associated with said vehicle service event.

By providing independently accessible storage units, the storage need not be limited to key acceptance/dispensing/storage. Each storage unit is limited only by size, unlike other systems which use a common vending-machine type of key dispensing and/or management.

Independently accessible storage units provide critical redundancy and security features. Since the mechanisms are simple, they are less prone to failure and provide for continued operation of remaining storage features upon failure of one or some units. Moreover, they provide for the pre-allocation of storage units in which other non-key items may be stored for transfer to the vehicle owner upon, or along with, key exchange.

In addition, the combination of independently accessible storage units along with access to independent third-party data sources, which in many embodiments are collected for purposes unrelated to key transfer and therefore separate from the key transfer system, provides for unique opportunities. For example, the use of vehicle-specific storage units along with access to a DMS system, means that warranty-specific information, including current and upcoming service information can be transferred to a vehicle owner at the time of key transfer without requiring a service representative to spend time assessing upcoming needs for a vehicle owner. Moreover, payment can be addressed in advance prior to exchange of keys.

Communication systems associated with the key transfer system means that vehicle- and owner-specific information can be obtained and used to determine vehicle- and owner-specific requirements that could be conveniently addressed at the time of key transfer.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 depicts an exterior isometric view of an embodiment of a service kiosk;

FIG. 2 depicts a block diagram of an embodiment of a computer system that would reside inside a service kiosk system;

FIG. 3 depicts a block diagram of an embodiment of a service kiosk system/ecosystem;

FIG. 4 depicts a block diagram of an embodiment of a computer system capable of implementing the methods for performing an automotive service, consistent with the disclosure of the present application;

FIG. 5A depicts a rear exterior isometric view of an embodiment of the service kiosk with an additional view of interior view multi-unit key storage facility;

FIG. 5B depicts a front exterior isometric view of the embodiment of FIG. 5A of the service kiosk with an additional view of interior view multi-unit key storage facility;

FIG. 5C depicts a right-side top front exterior isometric view of the embodiment of FIG. 5A of the service kiosk with an additional view of interior view multi-unit key storage facility;

FIG. 6A depicts a bottom rear isometric view of an independently accessible storage unit sliding drawer for use in a service kiosk multi-unit key storage unit module depicted in FIGS. 6B and 6C;

FIG. 6B depicts a rear interior isometric view of an embodiment of the sliding drawers of FIG. 6A installed in the service kiosk multi-unit key storage unit module;

FIG. 6C depicts a left-side front isometric view of an embodiment of the sliding drawers of FIG. 6A installed in the service kiosk multi-unit key storage unit module;

FIG. 7A depicts a top isometric view of an embodiment of a single sliding drawer of the service kiosk multi-unit key storage unit module;

FIG. 7B depicts an rear isometric view of the embodiment of a single sliding drawer of the service kiosk multi-unit key storage unit module shown in FIG. 7A;

FIG. 7C depicts a left-side view of the embodiment of a single sliding drawer of the service kiosk multi-unit key storage unit module shown in FIG. 7A; and

FIG. 8 depicts a view of an embodiment of a service kiosk dashboard.

FIG. 9 depicts an exterior isometric view of another embodiment of a service kiosk.

FIG. 10 depicts an exterior isometric rear view of the other embodiment of a service kiosk, showing the interior of said embodiment.

FIG. 11 depicts an exterior isometric view of a further embodiment of a service kiosk.

FIG. 12 depicts a front elevation view of the embodiment of a service kiosk shown in FIG. 11.

FIG. 13 depicts a rear elevation view of the embodiment of a service kiosk shown in FIG. 11.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise. The systems and methods described herein provide, in accordance with different embodiments, different examples in which

Procuring goods and services from a retailer or shop can be limiting due to the limitation presented when the transaction and/or exchange of information needs to occur in person or at a specific physical location. This engagement model can be restrictive due to the limited hours of operation of the seller and may conflict with the schedule of their potential clientele. A better solution would be to find a new engagement model where both parties could operate on independent schedules and still get what they require out of the relationship, whether transactional or high-touch service. This new solution may involve the exchange of sensitive information such as personal data, monetary funds, keys, high-value goods, etc. and would need to incorporate data security measures required to safely pass information between the parties.

Expanding on the idea of exchanging goods or services between two parties, namely the seller and buyer, there may be added value in being able to access a third-party database in order to add information related to the transaction. For example, if we consider automotive repair services then the additional information from a third-party database such as a dealer management system may be useful to inform decisions related to warranties, recommended repair schedule, recommended value-add purchases and historical information about a specific vehicle and specific preferences of the owner of that vehicle. A further example may be a mortgage broker specialist that may need to refer to a third-party database, such as a credit score database, as part of their approval process to authorize a client for mortgage and financing approval.

In some embodiments, the independently accessible storage units that can are assigned specifically for a particular vehicle (or indeed other type of lockable user entity) provides an opportunity for secure and streamlined key exchange without the need for both of the parties involved in an exchange of control over the lockable user attending at the point of exchange. In the case of a virtual key, the transfer of control over the key is completely location independent. Moreover, because the storage units are independently accessible, with each unit having its own releasing mechanism, security over the material stored therein is significantly increased. Reliability of operation is likewise improved since there is no single point of failure (if one unit fails, it is simply removed from service while the other units are maintained operational), and because the mechanisms for each unit are relatively simple (i.e. sliding mechanism or a hinge, a lock, and optionally an opening device, such as a spring or other mechanical object for storing energy, to provide motive force for the unit to move into an open position upon unlocking of the lock). Further, the independently units are therefore not limited to storing keys. During a transfer of keys, there is an opportunity and sometimes a necessity to transfer other materials at the same time. This could include paperwork (which is important in warranty-related work and in existing work processes in the automotive industry), small repair parts (e.g. paint-chip repair applicators), other keys (e.g. keys for a pre-arranged rental), and other related parts (e.g. wheel lock nuts, which are uniquely specific to the wheels of a given automobile that are necessary to remove its wheels). In these and other cases, it may be desirable to pre-allocate a storage unit for a particular user or key exchange. Moreover, by providing a means for connecting pre-existing third-party independent data systems that collect and administer data in association with services and/or administration thereof relating to a vehicle that has been transferred to a vehicle service provider, there are numerous opportunities ensure that vital services, or services that would be convenient to provide simultaneously with such vital services, particularly based on the history and/or preferences of the driver (or other owner/controller) of the vehicle (or other lockable user entity). Further, by having access to other related data which is collected for other reasons, the key system is configured to communicate directly with the owner or driver of the vehicle to address a number of issues quickly or in advance (including payment, consent to proceed with certain service activities, notifications, warranty agreements and signatures, booking future appointments, etc.), the time spent at a service provider to exchange keys or other items is minimized.

Embodiments of the present disclosure may improve upon existing methods and systems for procuring goods and services by providing access to a secured service kiosk twenty-four hours a day. While embodiments of the present disclosure may focus on automotive and vehicle services as an example, it should be well understood that the types of services offered by the kiosk should not be construed or limited to such automotive services. Embodiments of the service kiosk may be applied to any types of industries that a customer may order or procure services in exchange for payment and deposit or receive a key in return. For example, in addition to picking up and dropping of keys for automotive service, similar service kiosks may be used for procuring access to ride sharing services, hotels, time shares, rental cars, recreational rentals such as motorcycles, go-carts and ATVs, and procuring storage lockers or self-storage spaces.

Embodiments of the secured service kiosk may schedule service appointments or other types of available service on behalf of customers, provide a secure storage area for keys belonging to the vehicle or vendor, being dropped off or retrieved after service is complete and allow secure payment to the service provider through the kiosk. As a result of the service kiosk being available 24 hours/day and in light of the service kiosk being entirely automated, a customer can schedule services, drop off and pick up the customer's vehicle at any time that may be convenient for the customer. The customer does not have to waste time interacting with the employees of the service provider or vendor during normal business hours or schedule an appointment ahead time, thus allowing for hassle-free services, including repairs and maintenance.

In one embodiment, there is provided a system for releasably storing keys in independently accessible storage units, sometimes referred to herein as a service kiosk or service kiosk system. The keys are for providing access for a keyholder to an automobile or other lockable user entity, including but not limited to automobiles and other vehicles, such as but not limited to cars, trucks, motorcycles, boats, locomotives; housing, temporary or otherwise, such as but not limited to apartments, hotel rooms, houses, offices, storage facilities; and other vehicles or facilities whose access thereto, or control thereover, require the use of a key. While numerous embodiments described herein refer to a car or automobile, the key storage system described herein could be used with other lockable user entities without departing from this disclosure. Moreover, DMS is used to describe a third-party independent data source, or information management system, but other third-party data systems could be used. Likewise, automobile service or sales centers, and the related concepts of automobile parts ordering services, automobile warranty administration services, automobile financing information services, automobile insurance information systems, automobile collision and repair history services (e.g. relating to DIN), are referred to herein as exemplary third-party data systems hereinbelow, but other third party data systems may be used, which may related to other types of lockable user entities other than automobiles.

In some embodiments, the independently accessible storage units provide for a transfer of control over the vehicle from or to the owner or controller thereof to, for example, a service provider, without the need for personal interaction therebetween. Upon such transfer of control, there is generally a number of other actions or decisions that must be made at that point in time, or alternatively, are a convenient time for taking such actions or decisions. Generally, many of these actions or decisions have historically required personal interaction between the granter and the receiver of the key.

In some embodiments, the key can be any item or token, including a virtual one, that provides someone with control thereover to assume control and/or access to a vehicle or lockable storage user entity. In embodiments, this includes a key, or RFID fob, used for locking and unlocking, as well as starting engines on, cars or other types of automobiles and vehicles. In some cases, it is for granting access rights to a lockable user entity only; for example, a residence or storage unit would be for access. In the case of a virtual key, the key may be transferred from one user's device to another user devices, such device being, for example, a smart phone or key fob, upon a request by the owner (which for the purposes of this disclosure, an “owner” shall include the person who owns a vehicle, or who retains the right or title in an interest to the vehicle, and so would include a current renter or lessee of the lockable user entity). Such a virtual key may comprise a public-private key pair, or combinations thereof, so as to enable a device to operate as a key upon transfer of the appropriate key information. In such cases, the user's device, such as a smart phone may operate on a basis of proximity, in which the key storage system can detect and identify the user approaching, based on the proximity of the appropriately matching key from the public-private key pair, and upon such detection, the system may cause the appropriate storage unit to open automatically, and/or, optionally, the user interface of the system (or alternatively on the user's phone) to automatically prompt the user to take any actions or decisions required of them (e.g. make a payment, electronically or otherwise; sign documentation, electronically or otherwise for paperwork that may be stored in a storage unit; take or leave a wheel-lock nut; etc.). In other embodiments, the transfer may not require a physical storage unit where there is no physical key, or required transfer of other physical items. In other embodiments, a virtual token may be placed on the user's device in an analogous manner to that described above for transfer of physical keys stored in the key storage system.

In some embodiments, there is provided a method for securely transferring virtual keys for vehicles that are associated with remotely-stored independent third-party vehicle information, such as a DMS. Such embodiments may use a key storage distribution server, that stores information relating to the virtual key and associates that information with information relating to authorized and credentialed users of said virtual key. This information may change in real-time, for example, when a vehicle owner authorizes a service centre to take control of the vehicle, the service centre authorizes certain representatives to control the vehicle only at certain times or when certain steps in the service event or events have been completed (or are in progress), or when a vehicle is leased or rented to another. This information may be stored in a virtual key storage resource which is accessible and managed by a key management processor, including to update the real-time authorization information, as well as to distribute the virtual keys to the authorized users. The virtual keys may comprise a public-private key pair, which may be activated or deactivated in real time. By transferring the virtual key to an appropriate device having the necessary communications interface (i.e. a Bluetooth transceiver), such as an end user mobile phone, the virtual key can be used to access and/or control (i.e. start) a vehicle. The key can be returned, or deactivated in analogous ways to the transfer of a physical key; moreover, the occurrence transfer of the virtual key provides a critical decision-making point, in the same way as does the occurrence of the transfer of a physical key, at which decisions relating to maintenance and other services can or should be made. In the case of a virtual key, this decision-making point is not bound to a physical kiosk system but rather to a virtual kiosk presented on an end user device using downloaded software (i.e. an app) or by accessing a web server via a browser that may, for example, provide software as a service for distributing, activating, returning, or deactivating virtual keys.

In some embodiments, each independently accessible storage unit comprises a unit-specific lock mechanism. This may include any type of lock or latch system known in the art without departing from the scope or spirit of the instant disclosure. In embodiments, the unlocking of the locking-mechanism will be triggered by an electronic unlocking signal sent by a processor upon the identity of the requesting user being verified thereby. The identity of the user is determined in a number of ways as described below, and includes but is not limited to the user imputing identifying information via an interface device on the storage facility (e.g. phone number, email address, password), or by the system collecting biometric information (e.g. fingerprint, eye scan, facial recognition, or other), or by information transmitted or pulled from a user-specific device, such as a mobile phone, or key fob, or RFID tag. Once the identity is established and verified by the processor, said processor either retrieves from local storage information relating to the storage unit associated with the user and, if applicable, their keys, or it assigns a storage unit if one has not already been so assigned (and stores said association in local storage). The processor transmits the unlock signal to the appropriate storage unit, which automatically unlocks. In some embodiments, a spring or other mechanical device causes the storage unit to open automatically.

In some embodiments, the system further comprises a communications bus for interfacing with third party information sources that are pre-existing and used in association with the lockable user entity, but generally for other independent uses and/or sources than those of the key storage system. For example, a dealer management system (DMS) is used to track service information at dealers, including, but not limited to service history, warranty requirements and warrant history, parts information, inventory, payment tracking, financing information, dealer administration, and service visit status third-party data storage facility. The third-party information may be stored in a third-party data storage facility that is stored at the facility where the key storage system is located (e.g. the service provider), but generally separate therefrom. The communications bus provides an interface for transmitting information to and receiving information from one or more third-party data repositories. The communications bus (or alternative the processor) is pre-configured with the necessary protocols, standards, and/or languages for communicating with the one or more third party data repositories. In some embodiments, the third-party data repositories are stored in association with a particular standard, language or protocol, including for example some proprietary DMS systems. In embodiments, the third-party data repositories provide their own third-party API (i.e. application programming interface). Such APIs, provide a programmable module that comprises a set of functions and procedures allowing the creation of applications that access the features or data of an operating system, application, or other service. In some embodiments, such API's can be pre-loaded into the local data storage to enable the processor of the key storage system to communicate with the third-party data repository and system for the purposes of pulling information therefrom relating to the vehicle, as well as to write information therein. In embodiments, the third-party system comprises information relating to the vehicle, or similar vehicles, but is used for, and exists independently of, the key storage system. The key storage system interfaces with the system to pull information to optimize, for example, how quick and easy key transfer occurs by addressing requirements in advance or in parallel, without human intervention or human interaction with the user, and to provide user-specific information or opportunities. The user-specific opportunities can be determined either through pulling existing third-party information, through analysis thereof, or through analysis of a combination of the pulled third-party information and the locally stored or acquired information.

In some embodiments, the communications bus is configured to communicate directly with a user, via, e.g., a smart phone or web interface. This can be done via an “app” or other downloadable application that is installed on a user device, or via a web or network interface that is generated dynamically at the user device when, for example, the user directs a web browser to a specific web address. The direct user communication provides a number of useful functions: it may be related to user identification to confirm email addresses or phone numbers used to identify a user; if the user device is so configured, the user device may use its own biometric analysis to confirm identity of a user (e.g. fingerprint or facial recognition); updates, scheduling information and requests, and requests for further information may be texted, emailed, or phoned to a user device; the user device may be used to provide information to the service provider, such as a recorded voice message indicating issues with or other specific requests relating to the vehicle; and direct payment options from the user device (e.g. Apple Pay™, email money transfer, etc.). In some embodiments, in the case of virtual keys, a transfer of such keys can be effected or withdrawn by the user directly from the user device.

In some embodiments, systems and devices disclosed herein comprise one or more user interface devices for receiving user-identifying information about users. Embodiments of the service kiosk system may operate by identifying the customer by using one of the following methods: manual user input of the customer's information, scanning information from some form of a physical device (examples: driver's license, smartphone, barcode), wireless transaction (examples: Bluetooth, NFC) or by use of biometric data (e.g. retina scan, fingerprint authentication). The service kiosk may obtain a record of the user, and information relating to the identification of the user including the user's personal information, vehicles, vehicle history and display a series of potential vehicles that may be serviced on the kiosk's user interface. This information may come from a third-party database or application, such a Dealer Management System (DMS), a bundled management information system for large equipment manufacturers or automotive industry car dealerships. The DMS system will contain software that manages automotive information related to vehicle information, scheduled maintenance, warranties, financial information and other data analytics. Once a vehicle has been selected, the kiosk may further display available services that may be provided by the service provider. A customer may select one or more of the provided services, learn more details about the service and schedule the performance of the service with the service provider.

Embodiments of the service kiosk 1000 may include a multi-unit key storage facility comprised of independently accessible storage units 107, where each independently accessible storage unit is configured to be unlocked independently of one another based on a digital unlocking signal that triggers a unit-specific lock mechanism. Embodiments of the service kiosk 1000 may also have included a way to connect to the kiosk system through a remote connection. In some embodiments, this connection could be made through a mobile application on a smartphone or online through software hosted on a web server accessible via a browser. Customers could also access the user interface on a screen, touch or otherwise, housed in the service kiosk directly at the physical location of the kiosk itself. Customers, through either remote or physical means, can access an interface welcome or initial page to access an existing service appointment or to create a new service appointment. Embodiments of the service kiosk 1000 may include a welcome screen displayed on a monitor 102 where customers will be able to select vehicle drop off and vehicle pick up; alternatively, aspects of the interface, or some or all of the interfacing steps described herein, may be implemented on a remote device, including a customer end user device such as a smart phone via an app or web browser

Customers can also request assistance or change language. In some embodiments, there is a Get Assistance button available on the welcome screen and at any point during the drop off or pick up process. When requesting service, a notification (e.g. email or SMS notification) is sent to the service representatives, optionally as configured via the interface. Such SMS notifications can be designated to be sent during specific hours and/or to specific service representatives. In addition to this, any workstations running the interface will pop up a notification stating which kiosk is requesting assistance.

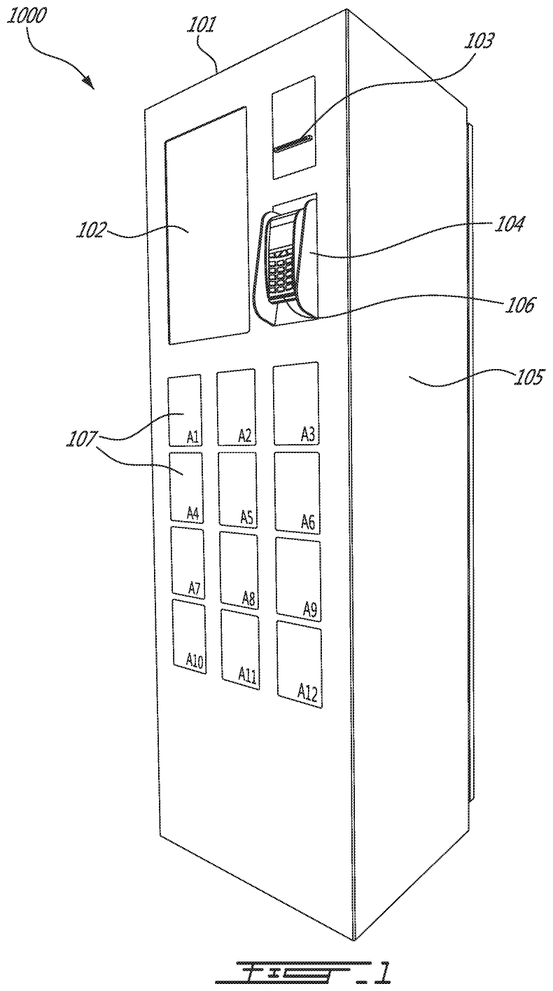

Referring to drawings, FIG. 1 depicts the external view of an embodiment of a service kiosk 1000 capable of performing a service transaction. Embodiments of the service kiosk 1000 may take any size, shape, and orientation and should not be limited to the embodiments depicted in the drawings, which are meant for illustrative purposes. The exterior surface 101 of the kiosk system may be decorated with ads, slogans, sponsors or helpful customer service information as shown in 105. Embodiments of the exterior surface 101 may be constructed out of any rigid material capable of encasing each of the components stored within the service kiosk 1000. The exterior surface 101 may prevent sensitive portions of the interior components of the service kiosk 1000 from being exposed or damaged from the surrounding environment outside of the service kiosk 1000. Examples of materials that may be used for constructing the kiosk system may include various metals, woods and plastics known by those skilled in the art such as stainless steel, galvanized plate, plywood, medium-density fiber board (MDF), polyurethane, UV coated polyurethane, acrylic, glass and tempered glass.

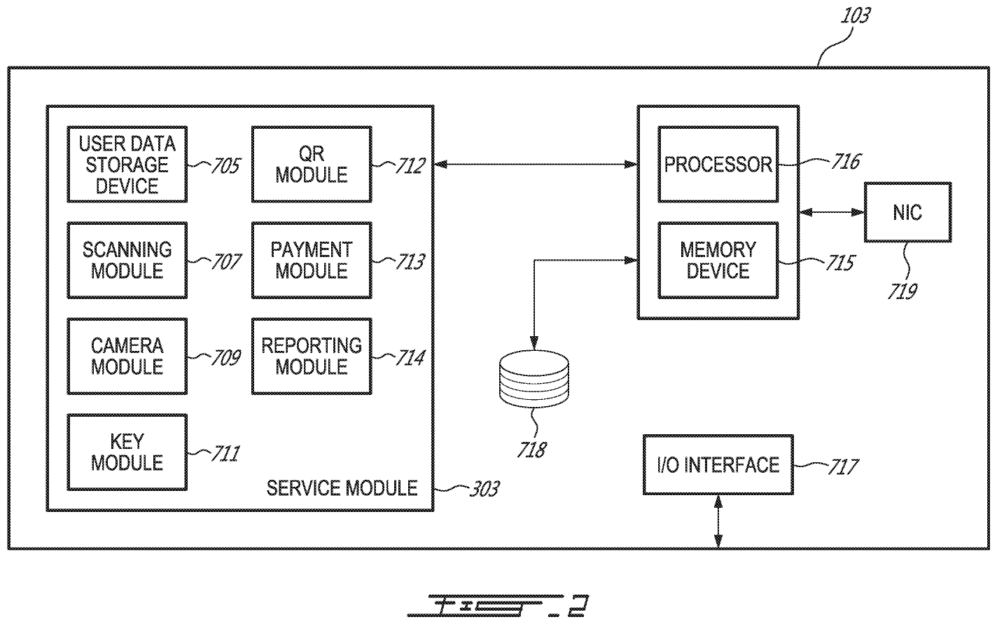

As shown in FIG. 2, embodiments of the kiosk system 2000 may include a plurality of components integrated into the kiosk system 2000 that may be accessible from the exterior surface 101 of the kiosk system 2000. Each of the plurality of components may perform a specific function or purpose as part of the kiosk's communication with the customer, identifying customer accounts, scheduling the customer's service appointment and/or returning the vehicle to the customer upon completion of the service appointment. The plurality of components that may be accessible via the exterior surface 101 of the kiosk system 2000 may include a speaker system (not shown), a card reader 106, a pin pad 104, a multi-unit key storage facility 107, a scanning device (not shown), a display device that may or may not be touch-controlled 102 and a camera system (not shown), a microphone (not shown), an RFID sensor/reader (not shown), and WIFI network interface (not shown), a Bluetooth™ interface (not shown), a telephone connection (not show), or other communications interfaces. Each of the individual components of the kiosk system may operate separately as a self-contained computing system or each of the interior components of the kiosk system 2000 may be electronically connected to a computer system 103.

In some embodiments of the kiosk system 2000, the speaker system (not shown) integrated into the kiosk system may output sounds and audio data, including instructions. In some embodiments, the speaker system may translate or recite text or visual data displayed by the display device 102 of the kiosk system 2000 to the customer. Embodiments of the speaker system may further be connected to a remotely accessible intercom system. Alternatively, the kiosk may be configured to directly communicate with a user device to request voice instructions therefrom, which gets recorded in kiosk data storage. A service representative or employee of the business tasked with providing the service to the customer, may speak to the customer through the speaker system, answer customer questions about the services offered or functionality of the kiosk system 2000, including to listen to instructions or comments from a customer via the microphone and telephone communications system (which could be over PSTN networks, mobile networks, or the internet, e.g. VOIP communications). Alternatively, the service representative, or the kiosk system itself, may be prompted to communicate directly with a customer phone upon receiving an SMS, and provide instructions through the speaker system of that phone. For example, a customer having difficulty operating the kiosk system 2000 to set up a service appointment may select the Get Assistance button and have an employee or customer service representative verbally dictate and/or walk the customer though the operation of the kiosk system 2000.

Embodiments of the kiosk system 2000, may include a payment system 129. The payment terminal 129 may perform the function of inputting customer payment information into the kiosk system 2000 and transmitting payment from the kiosk system 1000 to a payment processing system in order to complete a payment transaction for services rendered by the service provider. Embodiments of the payment terminal 129 may comprise a card reader 106 and a pin pad 108. The card reader 106 may allow for kiosk system 2000 to read data from credit cards and debit cards swiped through the card reader 106 in order to procure payment for the services performed by the service provider. The pin pad 104 may be an alpha numeric keypad for inputting credit or debit card information into the kiosk system 2000 or for interacting with the kiosk system 2000. For example, a customer may use the pin pad 108 to input a pin number or billing zip code associated with the credit or debit card previously inserted into the card reader 106, in order to complete a payment transaction. In some embodiments, the pin pad 104 may be utilized for directly inputting the credit or debit card number directly into the kiosk 2000 instead of swiping the card using the card reader 106. Further embodiments of the kiosk system 2000, may include access to the payment system 129 by mobile network capabilities or remote web-applications. This embodiment of the kiosk system 2000 would allow customers to pay in advance or at a separate time prior to picking up their vehicle.

In some embodiments, the kiosk system 2000 may include a camera system 127. The camera system 127 may be any recording system capable of recording and/or storing video data of the area in the vicinity of the kiosk system 2000. The camera system 127 may, in some embodiments operate as a security camera and a deterrent from individuals attempting to harm the service kiosk 1000 that may be left unsupervised by employees of the service provider. The camera system 127 may continuously record video data of the surroundings external to the service kiosk 1000 and store the video recordings within a computer storage device or remotely over a network to a network accessible storage device. In further embodiments, the camera system 127 may be used for identifying customers and subsequently loading customer information as a function of customer identification. For example, the camera system 127 may be loaded with facial recognition software or biometric scanning software. The camera system 127 may identify the customer upon the customer entering the view of the camera system 127, in front of the service kiosk 1000 and automatically load a user and/or vehicle profile from local (or cloud-based and/or remote storage) based on the facial or biometric recognition, or other user-identifying information of the customer collected by the user interface device or devices.

Embodiments of the service kiosk 1000 may include a display device 102. The display device 102 may output visual data from the kiosk system 2000. The visual data may include instructions or prompts displayed by an interface guiding the customer through the features of the kiosk system 2000, including selecting a profile, selecting services, scheduling the services, completing the payment process and the deposition or retrieval of keys. In some embodiments, the display device 102 may be a computer screen, monitor, television or other display device including cathode ray displays, light emitting diode displays, electroluminescent displays, plasma display panels, electronic paper displays, liquid crystal displays, organic light emitting diode display, etc. In the exemplary embodiment of the current application, the display device 102 may be a touch screen display device or a display device that provides haptic feedback. The touch screen display may allow for a user to enter commands and user input by touching the appropriate icon or input displayed by a graphical user interface 321 being displayed by the touch screen.

Additionally, embodiments of the kiosk system 2000 may include scanning device (not shown). The scanning device may be any scanning system capable of reading any type of machine readable representations of data that may be encoded into the data representation. Embodiments of the scanning device may read bar 1D and 2D codes. For example, the codes read by the scanning device may include universal product codes (UPC), EAN bar codes, Code 39 bar codes, code 128 bar codes, code 93 bar codes, ITF bar codes, Codabars, GS1 databars, MSI Plessey barcodes, QR codes, Datamatrix or micro-datamatrix codes, PDF417 or truncated PDF417 codes, Aztec codes, an any other type of coding system known by a person skilled in the art.

Embodiments of the service kiosk 1000 may leverage the use of the scanning system (not shown) for data storage and to recall user and/or vehicle profiles, which may include history relating to work orders, service summaries, product purchases, and vehicle information (both vehicle specific and vehicle class-specific, e.g. make, model, and year). For instance, in the exemplary embodiment, the scanning system may query a user database or user profile records by obtaining information from the user-input device. This include biometric identification, user input of user-specific information (e.g. phone number or email, which may in turn by authenticated), or proximity detection of an RFID tag or of another user-device. Scanning the barcode on the driver's license may also be used. User identification information is forwarded to the system processor, which, based on a positive authentication with an active user and/or vehicle, retrieves and loads a particular customer profile associated with the user and/or vehicle, which may comprise relevant customer information such as the customer's name, address, vehicle information and prior service records. Likewise, in some embodiments of the kiosk system 2000, a customer may receive printed receipts from a printing device 723 integrated into the service kiosk 1000 or an electronic receipt transmitted from the kiosk system 1000 to a customer's computing device. Each receipt (whether paper or electronic) may include a unique, scannable code that may be scanned by the scanning system. The unique scannable code may be attached to the user's profile, the services being rendered, the location of any keys provided to the kiosk system 2000, and, when printed out, attached to the keys themselves. The scanning system may scan the scannable codes presented on the paper or electronic receipt at the time the customer picks up the vehicle receiving service (or returns a key for another service provided by the kiosk) in order to load the corresponding customer profile information, a summary of the services rendered, the bill for services rendered, and to initiate retrieval of the customer's key or return a key for a rental vehicle, ride sharing service, hotel, timeshare, locker or other product that may be key operated.

Embodiments of the service kiosk 1000 may include a multi-unit key storage facility 107 for depositing and retrieving a key corresponding to the vehicle receiving service. A customer may initiate the deposit of the key when dropping off a vehicle for service and retrieve the key up picking up a vehicle after service has been completed and the appropriate payment has been made to the service provider. Each individual unit of the multi-unit key storage facility 107 may be accessed independently of one another and are openable, closable and/or lockable bin or container capable of being accessed from the exterior of the service kiosk 1000. Embodiments of the multi-unit key storage facility 107 fit flush with the exterior surface 101 of the service kiosk 1000. However, the actions for opening or closing the multi-unit key storage facility 107 may rotate, pivot or extend the zone from a closed to an open position. In further embodiments, when the multi-unit key storage is in the open position, a unit in the key storage facility may include a sliding shelf or sliding drawer wherein the storage unit may have a spring, self-aligning insertion and a sensor to indicate the presence of material inside the unit. In this embodiment, the unit specific lock mechanism is not accessible by the user or customer and may decrease the chance of tampering or breaking.

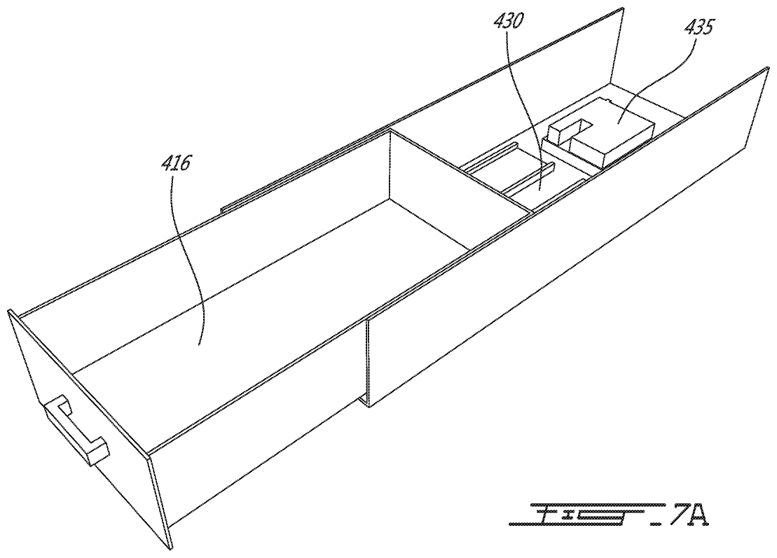

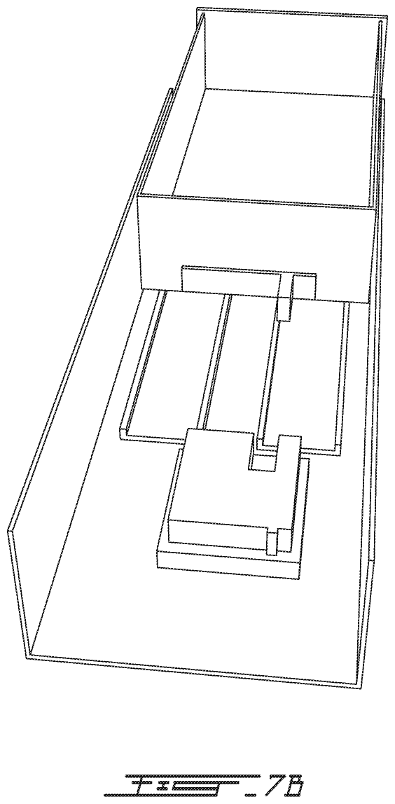

For example, in FIG. 1, both the multi-unit key storage facility 107 are placed in the closed position, wherein the interior contents of the multi-unit key storage facility 107 are not exposed from the exterior of the kiosk 1000. While the multi-unit key storage facility 107 are closed, the contents therein may not be viewable in some embodiments. In alternative embodiments, the multi-unit key storage facility 107 may be constructed out of a transparent or translucent material that may allow for a customer to see the contents of each unit multi-unit key storage facility 107 are in the closed position. Likewise, in FIG. 6C, an example of the kiosk 1000 is shown wherein the multi-unit key storage facility 107 is placed in an open configuration. As shown, the multi-unit key storage facility may pivot or rotate forward, revealing a sliding drawer for receiving the key wherein the storage unit may have a spring, self-aligning insertion and a sensor to indicate the presence of material inside the unit. Upon closing the multi-unit key storage facility 107 by sliding the drawer forward, the key may be deposited into the kiosk 1000 for secure storage while waiting to begin service on the vehicle.

Embodiments of the assigned multi-unit key storage facility 107 holding the keys may be accessed from the exterior of the kiosk 1000 by a customer. For example, a customer may request the retrieval of the keys from the assigned multi-unit key storage facility 107 selecting to pick up the customer's vehicle from the service provider using the vehicle drop off process. The kiosk system 2000 will display information on the monitor 102 regarding the assigned the unit of the multi-unit key storage facility 107 in which to deposit the keys belonging to the customer and for the assigned service. In some embodiments, a motor or latch or spring-loaded latch will initiate and release the assigned unit of the multi-unit key storage facility 107. In some embodiments, the process for releasing the latch may use a digital unlocking signal that triggers a unit-specific lock mechanism. Upon initiating the motor or latch or spring-loaded latch, may open the multi-unit key storage facility 107 causing allowing the customer to deposit the key in the specified unit of the multi-unit key storage facility 107. Further embodiments, such as the vehicle pickup process with follow a similar process to that of the vehicle drop off process. In this case, a customer would select the vehicle pickup option and the assigned unit in the multi-unit key storage facility 107 will initiate the motor, latch or spring-loaded latch which will open the assigned unit of the multi-unit key storage facility 107 and the customer can pick up the key to their vehicle.

In further embodiments, an employee of the service provider may unlock the kiosk 1000 of the specifically assigned unit of the multi-unit key storage facility 107, by using a digital signal similar to that of a customer or by using a mechanical lock, and acquire the keys stored within the kiosk 1000 in order to perform the service on the vehicle or move the vehicle from the initial drop off point to a more appropriate position. In some embodiments, upon completion of the service, the keys may be manually returned to the assigned unit of the multi-unit key storage facility 107 by the employee of the service provider. In further embodiments, when physical keys may be replaced with a digital alternative solution, the service provider and customer and service may engage service through digital authentication to access a vehicle. In some embodiments, the unlocking could be done through a smartphone and no physical or traditional key would be needed to unlock the vehicle. For security purposes, the service provider may be assigned a temporary digital authentication to facilitate the process. In similar embodiments, a pin pad may exist on the vehicle and a temporary code may be provided by the customer to the service provider in order for the service provider to unlock the vehicle.

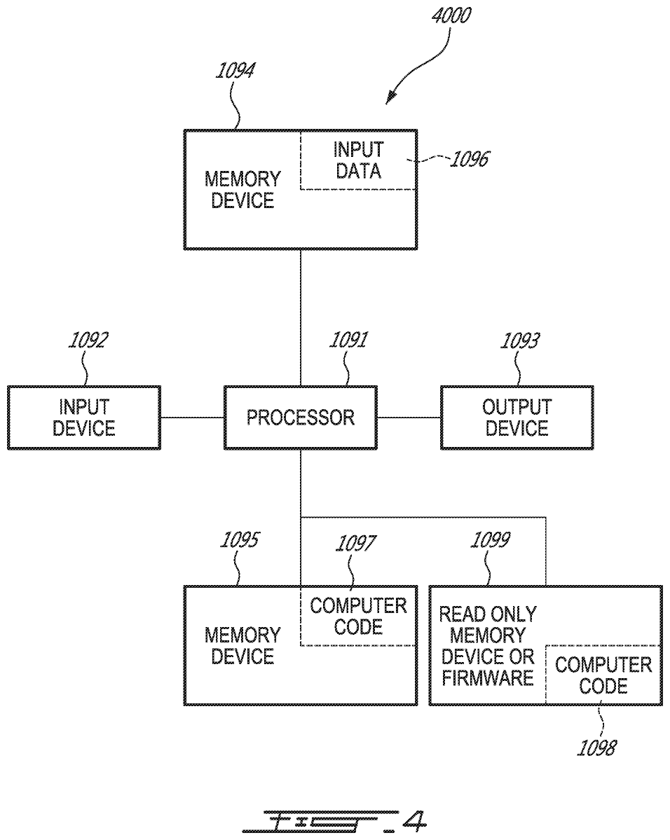

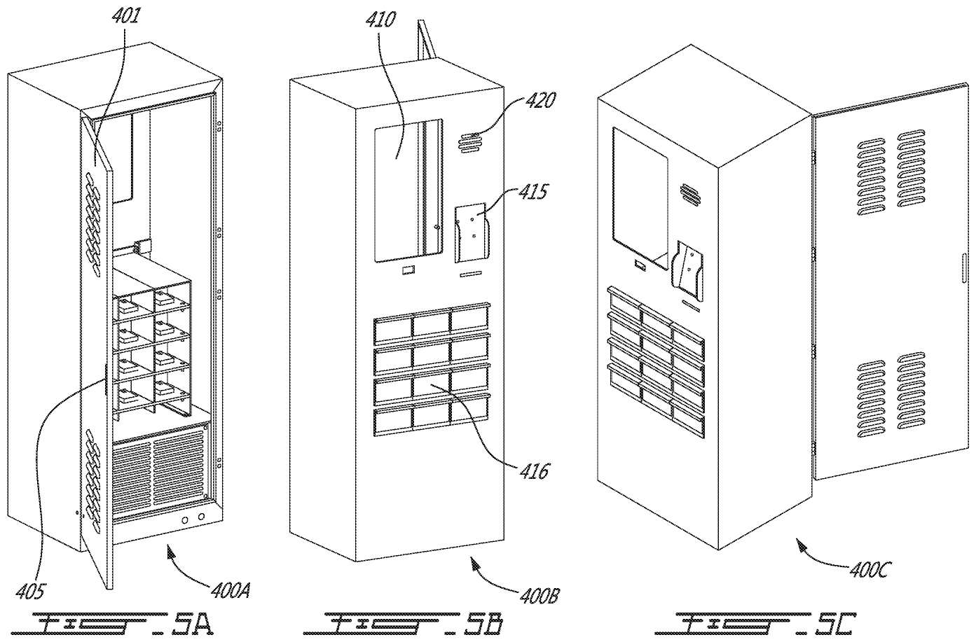

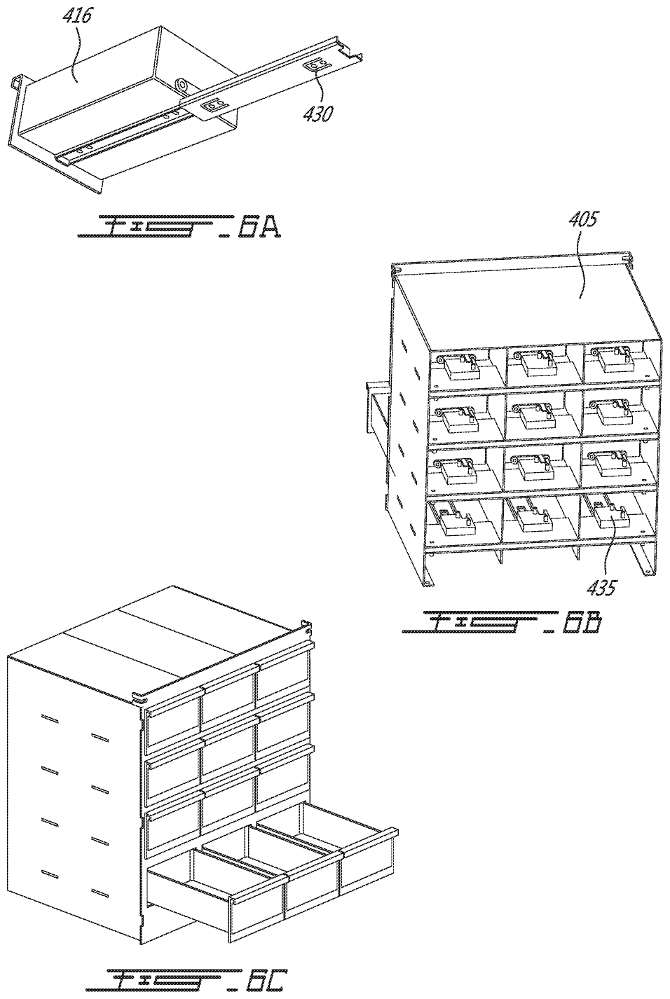

Referring to FIGS. 5A to 5C, there are provided a views of one embodiment of the kiosk 1000 from three views 400A, 400B, 400C showing the exterior of such housing, and aspects of the interior thereof. In this embodiment, the kiosk 1000 is openable from the rear panel 401, typically for providing access for maintenance. In this embodiment, there is a modular group of key storage units 405 is shown, which comprise of multiple slider- or drawer-type storage units 416. In some embodiments, the modular group may be removed from one kiosk for use in another kiosk, for example if there is a mechanical issue in a given kiosk and a different set of key storage units is required therefor. There is shown an opening 410 for a touch display interface (not shown), as well as a payment receiving input device holding device 415. There is also shown a speaker opening 420 for placing an optional speaker.

Referring to FIGS. 6A to 6C, there is shown a storage unit module 405 comprising of 12 independently accessible storage units 416, in which the bottom 3 units are shown in FIG. 6A an open position for illustrative purposes. FIG. 6B shows a single storage unit in association with a sliding member 430 configured to permit the storage unit 416 to slide from an open position to a closed position. A slide stop (not shown) may be used to stop the storage unit from disengaging from the kiosk system; optionally the stop may permit such disengagement upon lifting or tilting the storage unit when in an open position. In FIG. 6C, a rear view of the storage unit module 405 shows that each storage unit 416 comprises its own locking release mechanism 435. The locking release mechanism comprises a mechanical latch, bolt or other fastener that is engageable with the storage unit 416 to prevent movement from a closed position to an open position. Each locking release mechanism 435 may comprise its own processor and data storage device so as to provide unique additional functionality. In general, the locking release mechanism 435 is intended to receive unlocking signals, which trigger the locking release mechanism 435 to unlock, thereby permitting the storage unit 416 to open upon motive force causing the storage unit 416 to slide into an open position. The motive force may be supplied by a user or by an integral spring or other mechanical device (not shown). In general, pushing the sliding storage unit into the closed position sufficiently will cause the locking release mechanism to engage the storage unit 416 in a locked position. The locking release mechanism 435 is further configured in some embodiments to provide a confirmation signal that the storage unit 416 is closed and locked. In some embodiments there is provided a storage sensor (not shown) that detects the presence or lack thereof of keys or other materials in the storage unit 416, and the locking release mechanism 435 may be further configured to send information to the kiosk system processor indicating such presence of lack thereof. Unexpected circumstances, including a failure to lock, locking with no keys inside, or other such circumstances may trigger error messages, and or communications to the user, driver, or service representative. The locking release mechanism 435 may be further configure to send and receive other signals: lock release override or lock release trigger signal override (for either keeping lock engaged or disengaged), mechanical failure, open/closed indicators, existence and nature of contents, unauthorized opening, and other signals.

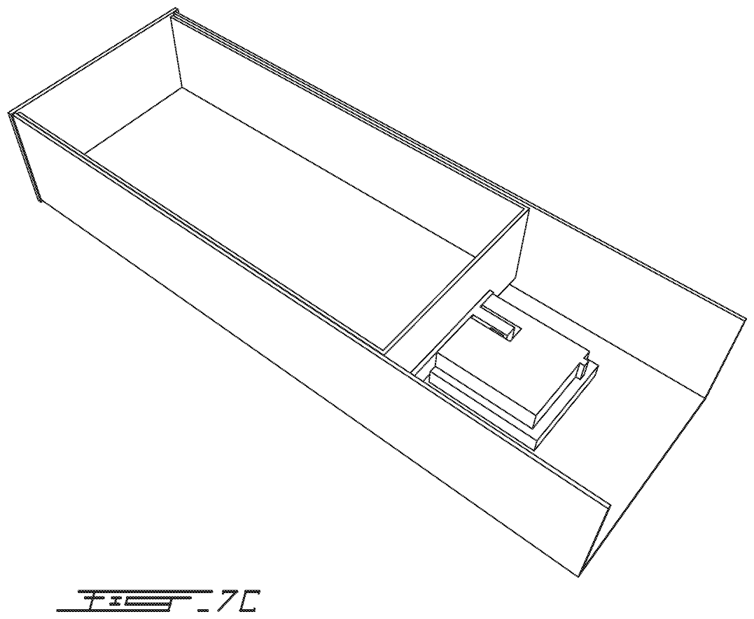

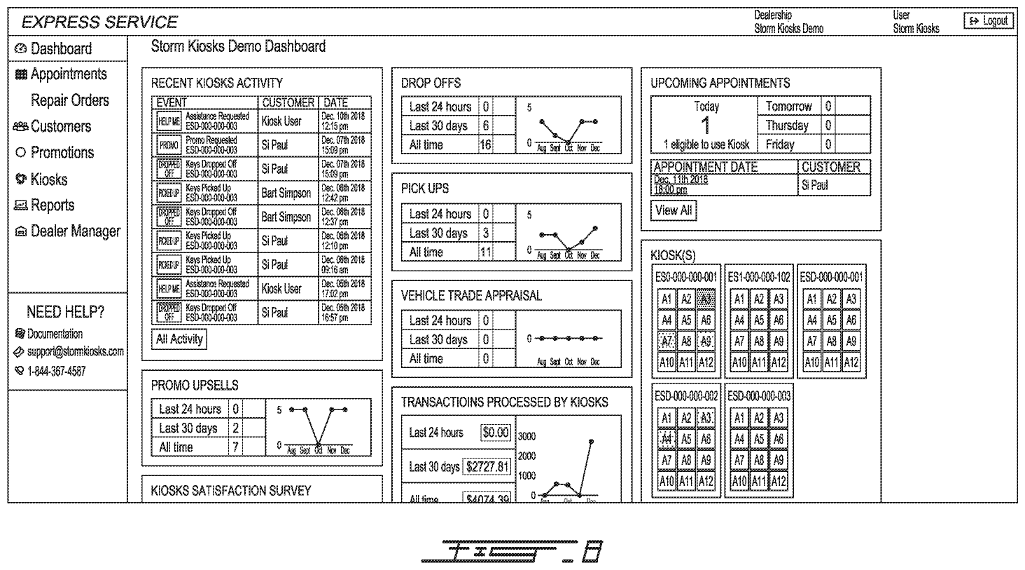

FIG. 7A shows, in greater detail, a storage unit 416 in an open position, as well as the sliding member 430, and the locking release mechanism 435. FIGS. 7B and 7C show the same storage unit 416 from different views, including further detail relating to the locking release mechanism 435; in the embodiment shown in FIGS. 7A, 7B, and 7C, a male locking tab is engageable with the female locking engagement location. The locking tab is released by the engagement location upon receipt of an unlocking signal. In some embodiments, the locking and unlocking of each individual are triggered by the same signal; in some cases, this is because the action of locking and unlocking occurs as a result of the same mechanical force, and in other cases, the unlocking signal simply toggles locked to unlocked, or unlocked to locked. Accordingly, the use of the term unlocking signal may in some embodiments also refer to a locking signal depending on the nature of the embodiment.

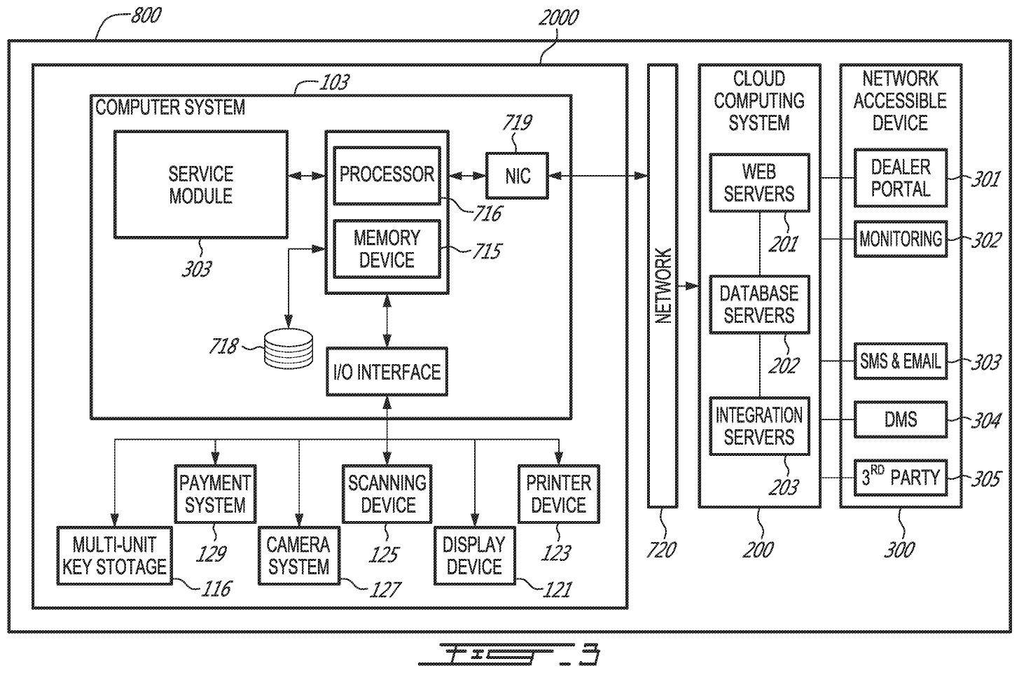

In some embodiments of the service kiosk 1000, each of the components integrated within the kiosk system 2000 may be connected to and/or controlled by a central computer processor 103. The embodiments of the kiosk system 2000 having an installed computer system 103 are illustrated in FIG. 2 and FIG. 3. Embodiments of the computer system 103 may connected through one or more input/output (I/O) interfaces 717 to each of the separate components of the kiosk system 2000 exchanging information between the computer system 103 and the components as either an input device or an output device. For example, the computer system 103 may be electronically connected to display device 102 (which is touch control enabled in some embodiments), scanning device 125, camera system 127, payment system 129, multi-unit key storage facility 107 and a printing device 723. The communications bus (not shown) is further configured to “pull” (i.e. send read requests) or to “push” (i.e. send write or update requests) to the third party data source or system; in addition, it may be used to communicate with a user device to, inter alia, utilize the device as the user interface device, send and receive notifications to or from the vehicle owner, activate virtual key transfer, receive or send verbal and textual descriptions relating to vehicle, interface with the kiosk system, actuate payment, send digital signatures, send and receive scheduling notifications, and other events described herein.

Embodiments of the computer system 103 may be a specialized computer system which may include a processor 716, specialized hardware or circuitry and/or software loaded in the data storage device 715 of the computer system 103. The embodiments of the computer system 103 may perform functions, tasks and routines relating to the scheduling and performance of an automotive transaction as described throughout this application. Embodiments of the specialized hardware and/or software integrated into the computer system 103 of the kiosk system 2000 may be part of a service module 703. Hardware and/or software components of the service module may include a user data storage device 705, camera module 709, key data storage location 711, QR module 712, payment module 713 and reporting module 714.

As used herein, the term “module” may refer to a hardware module, software-based module or a module may be a combination of hardware and software resources of the computer system 103 and/or resources remotely accessible to the computer system 103 via a computer network 720 and/or the I/O interface 717. The computer system 103 may be connected and placed in communication with other network accessible computing devices in some embodiments, including a cloud computing network 200 providing content from or to the kiosk system 2000. In some embodiments, the cloud computing network 200 may be comprised of a web server 201, database servers 202 and integration servers 203. In some embodiments, the web server 201 may be an HTTP server such as Apache server which is comprised of open-source cross-platform web server software. Further embodiments of the web server 201 would provide a connection to a dealer portal 301 or web monitoring 302. In some embodiments, the database servers are a My SQL is an open-source relational database management system. In further embodiments, the cloud computing network 200 may be connected to other third-party computing devices and applications such as SMS & Email server 303, Dealer Management System (DMS) 304 and other third-party vendor systems 305. In some embodiments, the SMS & Email server 303 will provide communication access between the dealer, customer and service provider regarding information related to the services. The DMS 304 will be able to access information relating to the dealer information specific to the vehicle in service. Such related information may include warranty information, scheduled maintenance, vehicle resale value, recommended products and services, etc. Further embodiments related to third-party vendor systems may include connection to car rental services, ride sharing services, taxi services, car dealer sales departments, car wash and detailing services, etc.

Embodiments of the network 720 may be constructed using wired or wireless connections between each computing device connected to the network 720. As shown in the exemplary embodiment of the kiosk ecosystem 800 of FIG. 3, each of the computing devices 103 may connect to the network 720 and communicate over the network 720 using a network interface controller (NIC) 719 or another network communication device. Embodiments of the MC 719 may implement specialized electronic circuitry allowing for communication using a specific physical layer and a data link layer standard, such as Ethernet, Fiber channel, Wi-Fi or Token Ring. The MC 719 may further allow for a full network protocol stack, enabling communication over network 720 to the group of computing devices or other computing hardware devices linked together through communication channels. The network 720 may facilitate communication and resource sharing among the computer computing devices 103 and additional hardware. Examples of network 720 may include a local area network (LAN), home area network (HAN), wide area network (WAN), back bone networks (BBN), peer to peer networks (P2P), campus networks, enterprise networks, the Internet, and any other network known by a person skilled in the art. In the exemplary embodiment of the service kiosk 1000, the kiosk may be connected through a cloud computing network 200 to the network accessible computing devices 300.

Embodiments of the modules described in this application, whether comprising hardware, software or a combination of resources thereof, may be designed to implement or execute one or more particular functions, tasks or routines of the computer system 103 and the kiosk system 2000 as described herein. Embodiments of hardware-based modules may include self-contained components such as chipsets, specialized circuitry and one or more data storage devices comprising a memory storage medium. A software-based module as shown in FIG. 4 may be part of a program code or linked to program code or computer code 1097, 1098 containing specific programmed instructions loaded into the data storage device 715 of the respective computer system 103, and/or a remotely accessible data storage device 715 of a network accessible computing device. For example, in some embodiments the network accessible computer device may be a web server, application server, or network accessible hardware, such as a network accessible storage device or repository 202.

Embodiments of the service module 703 may save, edit and load customer profiles; query and load customer profiles as a function of user-identifying information acquired through scanning a driver's license or biometric recognition of the customer through the camera system 127 or other biometric information, or customer query that may or may not include secondary authentication (e.g. when the customer inputs a phone number, and randomly determined verification code is texted thereto which must be input into the kiosk to authenticate a user); schedule automotive services tied to the customer's profile; collect, organize, store and retrieve customer keys from multi-unit key storage facility 107; print or transmit electronic receipts comprising a scannable codes; process customer payments to the service provider. In some embodiments of the computer system 103, the service module 703 may comprise one or more sub-modules that may be assigned to perform one or more particular tasks or functions of the computer system 103 and/or kiosk system 2000. The types and number of sub-modules may vary from embodiment to embodiment depending on the components and arrangement of components featured in the kiosk system 2000. However, in the exemplary embodiments of the computer system 103 shown in FIG. 2, the key storage system may comprise local data storage for storing digital information relating to information comprising data from or of user and vehicle data storage 705, scanning module 707, camera module 709, key data storage 711, QR module 712, payment module 713 and reporting module 714. In embodiments, local digital data storage for storing locally-stored information comprising information acquired from each of these modules, as well as information relating to user-identifying information, keys, storage units, users, vehicles, combinations thereof, and associations therebetween.

Embodiments of the local data storage 705 may save, edit, load and amend profile information about the customers accessing the kiosk system 2000. In some embodiments, information related to a customer may be stored locally in the computer system 103 on a local repository 718 or this data can be stored and queried on the cloud server network 200, namely the database servers 202 or they can be pulled from a third-party system such as a Dealer Management System (DMS) 304. A customer accessing the kiosk system 2000 for the first time may, in some embodiments, create a customer profile and store the customer profile locally in the local repository 718 or database of the kiosk system 2000. Alternatively, in some embodiments, the customer profiles may be stored on the network 720 in a network accessible repository 202 (database server or other computing device) allowing for the customer profile to subsequently be retrieved and loaded in each kiosk having access to the customer profile data. For example, a particular service provider may have multiple locations offering services to customers. The user data storage device 705 may access and provide the customer profile information stored on the network accessible repository 202, allowing for the kiosk 1000 to retrieve customer profile information regardless of whether the customer has previously visited the current location of the kiosk 1000 being accessed.

Embodiments of the customer/vehicle profiles accessed and amended by the user data storage device 705 may include customer information, including the customer's name, address, phone number and one or more vehicle makes and models owned by the customer. The customer profile accessed by the user data storage device 705 may further include a service history or service record for each of the vehicles associated with the customer's profile. The service history may be taken into account by the service module 703 when presenting one or more services available to the customer when the customer is selecting services to be scheduled for completion.

In some embodiments of the kiosk system 2000, the user data storage device 705 may be instructed to load a customer profile as a function of user input into the kiosk 1000. During the service scheduling and key drop-off phase of scheduling an automotive service, the customer profile may be loaded into the user data storage device 705 and displayed by the display device 102 using various methods. In some embodiments, a customer may select to manually input a customer's information into the computer system 103 of the kiosk system 2000. For example, the customer may use the touch screen of a display device 102 or the pin pad 104 to manually enter a customer's name, email address, cell phone number, vehicle information, VIN number, driver's license number or any other identifying information about the customer or the vehicle that would allow for the user data storage device 705 to identify the user and retrieve the profile either locally from the computer system's data repository 202 or remotely via a network 720 accessible resource.

In alternative embodiments, a customer may load a customer profile into the user data storage device 705 by using a scanning device (not shown) of the service kiosk 1000. In some embodiments, the scanning module 707 may work in conjunction with the user data storage device 705 to obtain user data relevant for loading the appropriate user or vehicle profile. Embodiments of the scanning module 707 may be responsible for decoding bar codes from driver's licenses as well as scannable codes presented during the pickup phase, identifying the type of code being presented and retrieving relevant information relating the information presented in the bar codes. For example, a customer may present a driver's license to the scanning device in order to login to the kiosk 1000 with the appropriate customer profiles. The scanning device may read the bar code or license number printed on the driver's license. The data encoded as the barcode may be transmitted from the scanning device to the scanning module 707, which is able to decode the scanned bar code data and further identity the decoded data as information obtained from a driver's license. The scanning module 707 may query a database or repository 202, which may contain records of customer driver's license for each customer registered with the service provider or kiosk company. The scanning module 707 may compare the driver's license data decoded by the scanning device with the customer records accessible to the computer device 103. Upon identifying a record of a customer profile that matches the data scanned from driver's license, the scanning module 707 may transmit the identified customer record to the user data storage device 705 so that the customer profile may be loaded into the data storage device 715 of the kiosk 1000 and displayed to the customer accessing the kiosk's monitor interface 102.

In some embodiments of the service module 703, a camera module 709 may be included. The camera module 709 may initiate, record, store and transmit video data recorded by the camera system 127 which may be integrated into the kiosk system 2000. The camera module 709 may perform the function of initiating or terminating the camera system 127 from recording video data of the exterior of the kiosk 1000. In some embodiments, the camera module 709 apply one or more facial recognition or biometric algorithms to identify a customer approaching the kiosk 1000 or entering the service provider's business. The camera module 709 receiving the video data from the camera system 127 may query a database of customer information to identify the customer based on the recorded facial or biometric features. The camera module 709 may track and/or alert the service provider when one or more particular customers have entered the business.

Further embodiments of the camera module 709, upon identifying the individual entering the service provider's business, may queue the customer's profile in the user data storage device 705. As the customer approaches the kiosk 1000, the kiosk 1000 may quickly load the previously identified customer's profile, cutting down on the amount of time needed to access the kiosk 1000 and streamlining the service selection or retrieval of the customer's vehicle. Moreover, in some embodiments, the camera module 709 may further be used direct the camera system 127 to record a confirmation image of an object, such as a key being deposited or retrieved from the kiosk system 2000. The recordation of the object being deposited may ensure that the customer is depositing the proper object needed to providing service to the customer or properly returning the property of the service provider. In some embodiments, the camera system 127 may be equipped with object recognition software programmed to identify objects, such as keys being deposited. The object recognition software may further be equipped with a database of the service kiosk keys and may cross reference an image of a deposited key with the returned key, which may further demonstrate that a customer has received the correct property back or that the kiosk is receiving the correct key up on return of the customer.

Embodiments of the service module 703 may include a key module 711. The key module 711 may perform the task of assigning specific units in the multi-unit key storage facility 107 to each of the keys deposited within kiosk 1000 and may also trigger a digital unlocking signal to release the keys from the assigned unit in the multi-unit key storage facility 107 upon receiving a request by the kiosk 1000 to retrieve the key from the key storage system 116. In some embodiments, the assigned unit in the multi-unit key storage facility 107 may also be independently and remotely locked by the kiosk 1000 using an electronic lock, to prevent tampering with the kiosk 1000. The key module 711 may be responsible for engaging and/or releasing the electronic locks of the multi-unit key storage facility 107 using a digital unlocking signal that triggers a unit-specific lock mechanism to open/close and allow for the deposition or retrieval of keys from the kiosk 1000. Instructions to open the assigned unit in the multi-unit key storage 107 may not occur in some embodiments until after the customer has been identified and the appropriate services have been finalized with the kiosk system 1000. Likewise, in some embodiments the assigned unit in the multi-unit key storage of the kiosk 1000 may be electronically locked and maintained by the key module 711 until the key being retrieved by the customer has been released from the assigned unit in the multi-unit key storage facility 107. Electronically locking the assigned unit in the multi-unit key storage facility 107 may prevent customers from tampering with the kiosk 1000 or inserting inappropriate objects into the kiosk 1000 as well as prevent customers from inadvertently attempting to deposit keys in the multi-unit key storage facility 107.

Embodiments of the key module 711 may further generate scannable codes encoded with customer identifying information and key storage information, including information of the assigned unit in the multi-unit key storage facility 107 assigned to hold the customer's keys. In some embodiments, the key module 711 may be with a program code or algorithm for generating a scannable code, such as a QR code or UPC code. In alternative embodiments, the generation of the scannable code assigned to a customer's service order may be generated by a separate module from the key module 711. For example, in the embodiment 800, of the kiosk ecosystem, a QR module 712 may be used separately from the key module 711 to generate the scannable code (i.e. a QR code).

In some embodiments, upon execution of the service order and/or deposit of the key, the key module 711 and/or QR module 712 may generate the scannable code 520 and display, print or electronically transmit the scannable code to the customer. For example, in one embodiment, the scannable code may be generated and scannable code data may be transmitted to printer device 723, wherein the scannable code may be outputted onto a printed receipt at the kiosk 1000 and received by the customer. Alternatively, in another embodiment, the scannable code may be generated and transmitted over network 720 to a cloud application servers 200, wherein the scannable code may be electronically delivered to an application being executed by a customer's client device and/or delivered to a customer s email address registered in the customer's profile saved by the kiosk system 2000.

Embodiments of the service module 703, may further include a payment module 713. The payment module 713 may be responsible for receiving payment data entered into the kiosk system 2000 via the payment kiosk's payment system 129. For example, the payment module 713 may receive payment data from a credit card or debit card being read by the card reader 106. The payment data entered into the payment module 713 may be tied to a specific transaction for services rendered by the service provider. The payment module 713 may tender the payment data and transmit the payment information to a payment processing server or third-party payment processor, such as the requisite bank or credit card provider. In some alternative embodiments, alternative funding options may be available and tendered by the payment module 713. These alternative funding options may include internet-based payment systems such as PayPal, Apple Pay, Google Wallet, Bit Coin, Amazon Payment services, blockchain payment services or any other form of digital currency that may be accepted for payments. The payment module 713 may receive the payment data from the selected funding option and remotely access the authentication server via network 720 to confirm the legitimacy of the payment source and complete the transaction.

Embodiments of the service module 703 may further comprise a reporting module 714. A reporting module 714 may be tasked with the function of reporting service transactions to the customer, displaying the visual data of the user interface on the display device 102 and generating reports for the customer and/or the service provider to view. The reporting module 714 may generate reports detailing customer interactions with the kiosk system 2000, services ordered, patterns in customer usage including the most popular vehicle drop off and return time, total sales using the kiosk system 2000, the amount of value from upselling, customer service reports and complaints directed toward the service provider. The reporting module 714 may further generate detailed reports describing to the service provider the efficiency of the service provider's employees, services, average cost per transaction, the most popular vehicles serviced or maintained by the service provider and the most popular services rendered by the service provider as a function of customer data collected and/or stored by the kiosk system 2000.

In some embodiments, the reporting module 714 may be responsible for generating and transmitting alerts and notification to customers. The alerts or notifications may be sent via SMS, direct messaging to a client device, push notifications to a client device (customer cell phone or personal computer), email or any other communication system known by a person skilled in the art. The alerts and notification may include maintenance reminders, recommended services and coupons in some embodiments. In other embodiments, the alerts and notifications may inform the customer that the service provider has completed the requested services scheduled, the total cost of the service and an appropriate time to pick the vehicle up after the completion of the scheduled service.

In some embodiments, there may be an aggregation of data generated from multiple service kiosks, specifically coming from the individual reporting modules 714. This aggregated data could be stored and processed on the cloud computing network 200 in order to generate data analytics that could be useful to many groups including customers, service providers, dealers, and other third-party vendors. For example, the service providers could determine which sales promotions of third-party add-ons are selling well and correlate other data such as purchase time, vehicle model, customer profile. Further examples may include third-party vendors, such as a dealer management system 304, to review data from multiple reporting modules 714 understand whether customers are using recommendations of scheduled maintenance pushed by the DMS.

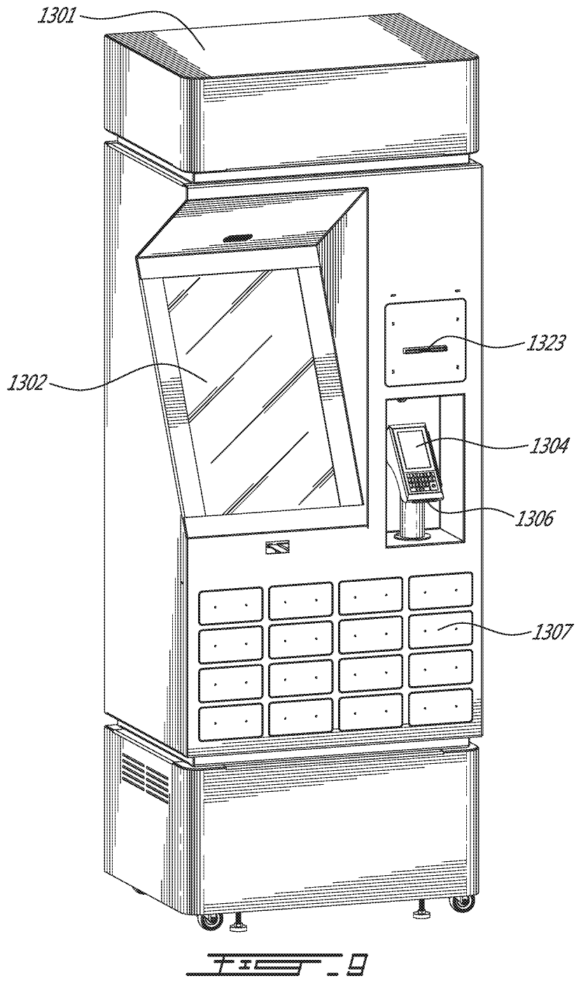

In some embodiments, there may be a dashboard as shown in FIG. 8 that displays the data from multiple service kiosks systems. This dashboard may display various data that may be useful to dealers managing multiple service kiosks. For example, the dashboard could display data related to recent kiosk activity 801, or aggregated data from multiple service kiosks (such as number of drop-offs/pickups, promo upsells, satisfaction surveys, transaction processed by each kiosk, etc.) 802, or data related to the status of the multi-unit key storage facility for each service kiosk 803. The dashboard system provides for the management of kiosk systems in numerous locations, as well as the analysis of service option offerings or other offerings in association with users and/or vehicles that share other common characteristics. Some embodiments may include AI to automatically determine effective combinations of service option offerings or other offerings and user or vehicle characteristics and automatically make those available to other users sharing those same characteristics (or whose vehicles share those characteristics) in the future.

Embodiments of the service kiosk includes a customer vehicle drop-off process. This process allows customers to look up their appointments, create new appointments and specify the services required on their vehicle. Upon successful completion, the customer will be instructed to place their vehicle keys in a vacant lock-box, which will be automatically opened by the kiosk software. The drop-off process also has voice-prompts to assist users, if enabled in specific embodiments.

In some embodiments and depending on dealership configuration, customers will be able to access pre-existing appointments or create a new appointment. In order to access existing appointments, customers can provide information via the interface. These can be manually added, or may be automatically pulled in via a DMS integration. Customer accounts may have a pre-existing identifier on file such as an email address or cell phone number, or in embodiments, may be required to provide one with certain authentication (e.g. human interaction and confirmation, credit card approval, secondary authentication via codes sent to SMS, etc.). Without this valid identifier, they may not be able to use the service kiosk in some embodiments. If the customer has multiple appointments, it will automatically select the next appointment for the drop-off process. Customers without appointments will also be able to create a new appointment on the kiosk. This feature is useful for those who arrive at the dealership after breaking down, or an unexpected repair. After successfully selecting their appointment (or creating a new one), the customer will be able update their vehicle information, such as mileage, and change their email address or cell phone number if required. In some embodiments, the software prompts the user for a vehicle appraisal, optionally using owner- or vehicle-specific information, in order to assess the vehicle value during service and then utilize that as a lead for a potential vehicle sale. If this option is selected, any configured “Sales Advisors” will receive an email or other indication containing the information relating to this interaction.

Embodiments of the service kiosk will provide the customer with the opportunity to select the services required for their vehicle; if services are present in the interface appointment editor or pulled via a DMS integration, they will be automatically pre-selected. The customer will also be able to add additional pre-determined services to their vehicle, such as a detail package or oil change. Time estimates can also be provided to the customer if desired. Warranty information, which may or may not be user- or vehicle-specific, may also be provided, such as recommended or upcoming maintenance. Furthermore, in some embodiments following the service selection screen, the customer can add any further information about their vehicle or service in an open text box. In some embodiments, the processor may be configured to determine a match between certain historical information or preferences relating to a specific user or vehicle and other information. This other information may include date and/or season and/or seasonal requirements, warranty information, failure to meet warranty requirements, current sales promotions on specific goods or services, insurance information, inventory information, resale information, payment information, customer priority, preferred customer status, customer reward levels, availability of ride share, taxi, loaner, or rental services and, optionally, whether a given customer should be granted credit therefor based on their priority, preferred status, or reward levels, and other information.

Embodiments of the service kiosk, if enabled, the dealership has an opportunity to provide promotions to the customer such as a discounted detail package or even a new vehicle. This promotion may be presented via the interface. The customer can choose to opt-in or out of this promotion. Trade appraisal prompts can also be enabled which encourages customers to opt-in their vehicle for a trade appraisal whilst it is in for service. In some embodiments, if the feature is enabled, any vehicle with mileage greater than a predetermined value will prompt the customer for a trade appraisal. Prior to depositing the keys an on-screen signature may be presented. At this time, the terms and conditions may also be presented to the customer (these can be configured by an administrator via the interface). The signatures may be stored electronically and viewed on the interface at a later time, or pulled from local data storage as may be required for warranty or other purposes.

In some embodiments, once the customer has signed the screen, a vacant door in the multi-unit key storage facility will automatically open, by means of the locking mechanism being triggered by the digital unlocking signal, and the customer is provided with on-screen instructions on how to deposit their keys. In the event the door lock is not automatically triggered, the customer has the option to trigger the lock again. Furthermore, in some embodiments following the door unlocking, a 6-digit service PIN is generated and sent via SMS text and email to the client. In some embodiments, there is provided a key-detection sensor, which may be activated by weight or pressure, or other detection means, to ensure that a key is present in the storage unit; if the customer or service representative is prompted to place a key in the storage unit and no key is in fact placed therein, the kiosk system may take additional action: the storage unit may be prevented from being closed and/or locked, an error message may be displayed, or the customer and/or a service representative may receive notification. The customer may, in some embodiments, use the PIN number to retrieve their keys once the service is complete. The service department may also be sent an email notification with the vehicle services selected by the customer, as well as other information (e.g. a voice recording, if the customer has provided one to the kiosk local storage via their smart phone or local microphone). If DMS write functions are available for appointments in a given DMS API, these will also be updated automatically in a DMS. In embodiments, a key indicator on an available interface will show how many keys are ready for retrieval from the kiosk. The appointment and appointment information can also be viewed and accessed via the interface.

In some embodiments of the service kiosk, the pick-up process allows customers to review their repair order, pay via the payment terminal and then collect their keys from the service kiosk. In order to successfully pick up their keys from the kiosk, they must be deposited in the kiosk by the service department once the vehicle service is complete. Furthermore, in some embodiments, each key is tied to a repair order in local data storage and viewable in the interface; these may be imported automatically if the DMS pull feature is available. Voice-prompts may be used to assist users in some embodiments. The customer can access their repair order by logging in, using authentication information discussed herein, including but not limited to their email address or cell phone number and the service PIN generated during appointment creation or repair order import/creation. In some embodiments, if the customer does not have a valid authentication information or other means they will not be able to use the kiosk to access their keys.

In some embodiments, if the keys are available in the kiosk and the customer successfully logs in, they will now be presented with their full repair order on-screen for review. The repair order can be scrolled using phone-style touch gestures. The subtotals and any taxes are also clearly displayed on-screen for the customer to review. At this stage, the customer may also check the box to “request a call from the service department” if they have issues with their repair order. They can also select a printed receipt—this is checked by default as a requirement of the payment processing companies. Please note that the full receipt and repair order break-down will be sent via email to the customer regardless of their selection. Prior to payment, the customer is provided an opportunity to review terms and conditions sign the screen, or provide some other form of acceptable digital signature. Locking release signals may be prohibited or regulated based on receipt of such review and digital signatures.

In some embodiments, if the repair order total cost is greater than zero, the customer will be prompted for payment. At this point, an animated image of the payment terminal is shown on screen, and the customer is directed to the payment terminal to complete the payment. If the payment fails or is declined, the customer will be directed back to the review repair order screen to attempt the payment again. In some cases, the full payment amount may be required, but partial payments or split payments may be supported in some embodiments. All transactions are logged, and successful payments are added to the repair order in local data storage (and in some embodiments written to the DMS data repository). Customers and service advisors may receive a copy of the receipt via digital communication, such as email or SMS. Upon successful payment (or a zero-amount repair order), the specific storage lock box containing the customers key will be automatically opened and the customer will receive on-screen instructions on how to collect their key. If parking/vehicle location instructions are provided by the service provider, they will be displayed on-screen so the user can locate their automobile. In the event the lock-box is not successfully opened, the client will have the option to try again. Furthermore, in some embodiments of the kiosk system, a user may select an appropriate payment type and provide payment to the service providers through the kiosk's payment processing system. For example, by entering a credit card into an onboard card reader, inserting cash into the kiosk or using a network accessible payment method such as PayPal, Apple Pay, Google Wallet, Amazon, Bitcoin or other electronic-based payment system.

In some embodiments, commercial trucks and towing companies could also use the service kiosk system and would follow the same process as has been described. There will be an option to drop off multiple keys by selecting the Commercial Drop Off selection. In some embodiments, this option is accessible by following these steps:
1. Enable New Appointments in dealership configuration
2. Touch “Drop Off” on the kiosk
3. Touch “Towing or transport company”
4. The simple form is completed by the driver and the door will open and prompt them to insert keys
5. Service advisors will receive notification of these drop-offs via email and text message; and they are also viewable in the interface.

In some embodiments, different type of users may be configured. In an exemplary embodiment, there are two access levels for service provider representatives:
1. Operator: With this access level, the user can only deposit or retrieve keys
2. Administrator: Administrators can also enable/disable doors, perform diagnostics or change system configuration. All actions in the service menu are logged via the audit trail which can be viewed in the web-interface.

In some embodiments, access to the login screen is provided via the system interface. Users may be provided with a unique PIN number to access the service menu. The retrieve keys option allows the removal keys from the kiosk that have been dropped off by customers. When selecting this option, a graphical representation of the lock-boxes is presented, displaying the names and vehicles currently available for retrieval (these are highlighted in blue). To remove that key, a user may select the desired storage unit and they keys will be released therefrom. In embodiments, a receipt will print or be sent directly to one or more devices (including a service representative, and/or the DMS, and/or a customer) showing, e.g., the customer's name, email address and cell phone number. This may be attached the keys for ease of identification. Once the vehicle service is complete, keys may be deposited back into the kiosk system. A graphical representation of the lock-boxes is shown in the interface, whereupon the service representative may select an empty lock box to deposit the keys and printed repair order (if necessary). On the next screen, the customer's service order can be identified by, e.g., entering their last name, email address, cell phone number, or RO number (or similar DMS identifier, if available). A list of matching repair orders will appear for selection, wherein the user may select the correct one by matching the date and total amount of the repair order. The repair order may be pulled from DMS to be available in the data storage, and may be required, prior to deposit of keys. Parking or vehicle location information to assist the customer in finding their vehicle may be accessible or stored locally. In some embodiments, pre-determined parking instructions can be configured via the interface to reduce time. Once the keys are deposited, the customer will receive automated notifications letting them know their vehicle is ready, and also reminding them of their PIN number; in embodiments, these notifications may be provided by email, SMS, or recorded voice calls.

In some embodiments, there is a kiosk system information analysis system for collecting information from individual kiosks at one more dealer locations, analyzing aggregated information therefrom, and providing results thereof to back to specific kiosks. This information may comprise circumstances in which specific events or actions should be triggered for specific users or vehicles that meet certain criteria. [More info here]

In some embodiments, if a storage unit is experiencing mechanical problems, it can be removed from use. When disabled, the system will not select that storage unit for drop-off and it will be unavailable for any other purpose until re-enabled. Referring to the drawings, FIG. 4 illustrates a block diagram of a computer system 4000 that may be included for implementing methods for performing an automotive service transaction in accordance with the embodiments described in the present disclosure. The computer system 4000 may generally comprise a processor 1091, otherwise referred to as a central processing unit (CPU), an input device 1092 coupled to the processor 1091, an output device 1093 coupled to the processor 1091, and data storage devices 1094 and 1095 each coupled to the processor 1091. The input device 1092, output device 1093 and data storage devices 1094, 1095 may each be coupled to the processor 1091 via a bus. Processor 1091 may perform computations and control the functions of computer 4000, including executing instructions included in the computer code 1097 for tools and programs implementing a method for performing an automotive service transaction in the manner prescribed by the embodiments of the disclosure, wherein the instructions of the computer code 1097 may be executed by processor 1091 via data storage device 1095. The computer code 1097 may include software or program instructions that may implement one or more algorithms for implementing the methods for performing an automotive service transaction, as described in detail throughout this application. The processor 1091 executes the computer code 1097. Processor 1091 may include a single processing unit, or may be distributed across one or more processing units in one or more locations (e.g. on a client and server).

The data storage device 1094 may include input data 1096. The input data 1096 includes any inputs required by the computer code 1097, 1098. The output device 1093 displays output from the computer code 1097, 1098. Either or both data storage devices 1094 and 1095 may be used as a computer usable storage medium (or program storage device) having a computer readable program embodied therein and/or having other data stored therein, wherein the computer readable program comprises the computer code 1097, 1098. Generally, a computer program product (or, alternatively, an article of manufacture) of the computer system 4000 may comprise said computer usable storage medium (or said program storage device).

Data storage devices 1094, 1095 include any known computer readable storage medium, including those described in detail below. In one embodiment, cache memory elements of data storage devices 1094, 1095 may provide temporary storage of at least some program code (e.g. computer code 1097, 1098) in order to reduce the number of times code must be retrieved from bulk storage while instructions of the computer code 1097, 1098 are executed. Moreover, similar to processor 1091, data storage devices 1094, 1095 may reside at a single physical location, including one or more types of data storage, or be distributed across a plurality of physical systems in various forms. Further, data storage devices 1094, 1095 can include data distributed across, for example, a local area network (LAN) or a wide area network (WAN). Further, data storage devices 1094, 1095 may include an operating system (not shown) and may include other systems not shown in the figures.

In some embodiments, rather than being stored and accessed from a hard drive, optical disc or other writeable, rewriteable, or removable hardware data storage device 1094, 1095, stored computer program code 1098 (e.g. including algorithms) may be stored on a static, non-removable, read-only storage medium such as a Read-Only Memory (ROM) device 1099, or may be accessed by processor 1091 directly from such a static, non-removable, read-only medium 1099. Similarly, in some embodiments, stored computer program code 1097 may be stored as computer readable firmware 1099, or may be accessed by processor 1091 directly from such firmware 1099, rather than from a more dynamic or removable hardware data-storage device 1095, such as a hard drive or optical disc.

In some embodiments, the computer system 4000 may further be coupled to an input/output (I/O) interface and a computer data storage unit (for example a data store, datamart or repository). An I/O interface may include any system for exchanging information to or from an input device 1092 or output device 1093. The input device 1092 may be, inter alia, a keyboard, joystick, trackball, touchpad, mouse, sensors, beacons, RFID tags, microphones, biometric input device, camera, timer, etc. The output device 1093 may be, inter alia, a printer, a plotter, a display device (such as a computer screen or monitor), a magnetic tape, a removable hard disk, a floppy disk, etc. The data storage devices 1094 and 1095 may be, inter alia, a hard disk, a floppy disk, a magnetic tape, an optical storage such as a compact disc (CD) or a digital video disc (DVD), a dynamic random-access memory (DRAM), a read-only memory (ROM), et. The bus may provide a communication link between each of the components in computer 4000, and may include any type of transmission link, including electrical, optical, wireless, etc.

The I/O interface may allow computer system 4000 to store information (e.g. data or program instructions such as program code 1097, 1098) on and retrieve the information from a computer data storage unit (not shown). Computer data storage units include any known computer-readable storage medium, which is described below. In one embodiment, computer data storage unit may be a non-volatile data storage device, such as a magnetic disk drive (i.e. hard disk drive) or an optical disc drive (e.g. a CD-ROM drive which receives a CD-ROM disk).

As will be appreciated by one skilled in the art, in a first embodiment, the present invention may be a system; in a second embodiment, the present invention may be a method; and in a third embodiment, the present invention may be a computer program product. Any of the components of the embodiments of the present invention can be deployed, managed, serviced, etc. by a service provider able to deploy or integrate computing infrastructure with respect to performing an automotive service transaction. Thus, an embodiment of the present invention discloses a process for supporting computer infrastructure, where the process includes providing at least one support service for at least one of integrating, hosting, maintaining and deploying computer-readable code (e.g. program code 1097, 1098) in a computer system (e.g. computer 4000) including one or more processor(s) 1091, wherein the processor(s) carry out instructions contained in the computer code 1097 causing the computer system to perform an automotive service transaction. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for performing an automotive service transaction. Thus, the subject matter described herein discloses a process for supporting, deploying and/or integrating computer infrastructure, integrating, hosting, maintaining, and deploying computer readable code into the computer system 4000, wherein the code in combination with the computer system 4000 is capable of performing a method of performing an automotive service transaction.

In some embodiments, there is provided a method for securely transferring keys between the owner of a vehicle (or other lockable entity) and service providers for that vehicle (or other lockable entity). In general, the method is implemented in association with a key transfer system having multiple independently accessible storage units, in which keys for vehicles associated with remotely-stored independent third-party vehicle information that is collected and used by the service provider for other reasons (e.g. tracking the service events associated with a given vehicle, as well inventory, financing information, payment information, historical information relating to vehicles and owners, sales information, warranty information, and other information relating to the vehicle that may be used by the service provider. In embodiments, the method may comprise at least some of the following steps.

Systems and devices provided hereunder are configured to interface with a pre-existing independent third-party data storage facility via a communications bus, and obtaining pre-existing vehicle-specific information. The pre-existing independent third-party data storage facility may be a DMS system, a manufacturer's warranty management system, an after-market parts or vehicle sales data base, or any other third-party information management system used to provide third-party services which require control or access to the vehicle (or other lockable entity). In some cases, the vehicle-specific information comprises vehicle information, vehicle owner information, and vehicle service event information from said third-party data storage facility. Accordingly, access to keys, or the ability to store a key, may be contingent on certain activities being completed, and/or statuses being achieved, in association with the vehicle related to the key that is stored, or is to be stored, in a particular key storage unit. For example, if a vehicle's complete service activities for a given service appointment have been started but are not completed, the kiosk may reserve a key storage unit for the keys associated with that vehicle, but not permit the unlocking signal to trigger the opening or unlocking of the unit so that the service representative may not place the keys therein; similarly, the vehicle owner may not access the unit to retrieve the key until payment has been received.

Systems and devices provided hereunder are configured to receive, via one or more user interface devices, user-identifying information relating to a user. This information is typically used to identify, and assign credentials, to a particular user who is wishing or attempting to acquire possession or control over the keys (and/or other subject matter contained in the storage units). In general, the user being is the vehicle owner or the person entitled to use or control the vehicle, or the user is a service-provider associated with the given vehicle or their representative. The user interface devices are generally used to collect one or more types of information that can be used to uniquely identify the user (or the class of user, e.g. authorized mechanic of the service provider). The interface devices may include a proximity-based sensor device, which may in some embodiment cause the applicable storage unit to open automatically upon the user being within a close range. The interface devices may include biometric sensors, such as facial or fingerprint recognition. The interface devices may include an interface for communicating with an end user device, such as mobile phone (which may itself act as the user interface).

Systems and devices provided hereunder are configured to allocate a key storage unit from the plurality thereof for storing a given vehicle-specific key associated with a given vehicle having vehicle information associated therewith stored in the data storage facility relating to one or more service events for said given vehicle. The allocation may occur in real-time when, for example, a vehicle owner interacts with a system to drop off keys at a service centre. Alternatively, the allocation may occur in advance. The allocation remains in place until the keys are transferred back to the owner and, if any materials are placed back in the storage unit (e.g. signed warranty documents), those are removed. Then the unit is made available for other key transfers.

Systems and devices provided hereunder are configured to transmit a digital unlocking signal to the first key storage unit allocated for the vehicle-specific key upon receipt by the key storage device of user-identifying information associated with said vehicle-specific key that provides the necessary credentials associated with the vehicle-owner (or other authorized user) that owns the keys or the vehicles associated therewith. Other information may be required prior to transmitting the unlocking signal, thereby opening the storage unit (or allowing it to open). This may include confirmation that payment has been received, that the customer has submitted a signed confirmation or acknowledgement relating to the services, (including a digital signature), or that a service is scheduled to take place for the vehicle in an upcoming time period.

Systems and devices provided hereunder are configured to generating one or more vehicle-specific service options relating to the given vehicle based on vehicle-specific information for the given vehicle from said third-party data storage facility. This may include inquiring with the vehicle owner with respect to other recommended maintenance or warranty work that may be required soon or recalls that may be associated with a given vehicle (and which may be associated specifically with a given vehicle or set of user requirements or preferences). This type of analysis may take place elsewhere and, in respect of which characteristics of interactions for which specific types of service options or other information offers or requests should be made, transmitted to the system so that upon the occurrence of such interactions in the future, associated service options or other information offers or requests can be presented to a vehicle owner upon drop off or pick up. This may further include specific options or benefits made available for certain types of customers, such as automatically arranging or presenting to vehicle owners benefits relating to alternative transportation or accommodation (e.g. credit for an Uber ride, and requesting an Uber ride, or alternatively a car rental). The service options or information requests or offers can be presented directly to vehicle owners via the touch screen or other user interface device on the system, or it can be communicated to the vehicle owner via another end user computing device (e.g. a mobile phone).

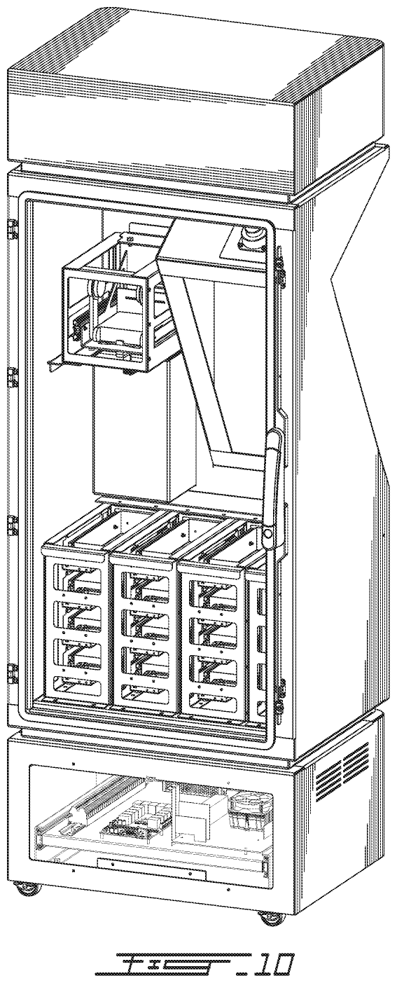

Referring to FIG. 9, there is shown another embodiment of the subject matter described herein. FIG. 9 shows the front view of another embodiment of a service kiosk 1300. The exterior surface 1301 may be constructed out of any rigid material capable of encasing each of the components stored within the service kiosk 1300. The exterior surface 1301 may prevent sensitive portions of the interior components of the service kiosk 1300 from being accessed, exposed, or damaged from the surrounding environment outside of the service kiosk 1000, including by unauthorized users. Examples of materials that may be used for constructing the kiosk system may include various metals, woods and plastics known by those skilled in the art such as stainless steel, galvanized plate, plywood, medium-density fiber board (MDF), polyurethane, UV coated polyurethane, acrylic, glass and tempered glass. The embodiment shown in FIG. 9 may include a plurality of components that may be accessible via the exterior surface 1301 of the kiosk system 1300 may include a speaker system (not shown), a card reader 1306, a pin pad 1304, a multi-unit key storage facility 1307, a scanning device (not shown), a display device that may or may not be touch-controlled 1302 and a camera system (not shown), a microphone (not shown), an RFID sensor/reader (not shown), and WIFI network interface (not shown), a Bluetooth™ interface (not shown), a telephone connection (not shown), or other communications interfaces. Each of the individual components of the kiosk system may operate separately as a self-contained computing system or each of the interior components of the kiosk system 1300 may be electronically connected to a computer system 103.

FIG. 10 shows a rear view of another embodiment of a service kiosk 1400. In this embodiment, there is a modular group of key storage units 1405 is shown. In this embodiment, there is a modular group of key storage units 1405 is shown. There is shown the rear view of an opening 1410 for a touch display interface, as well as the rear view of a payment receiving input device holding device 1415.

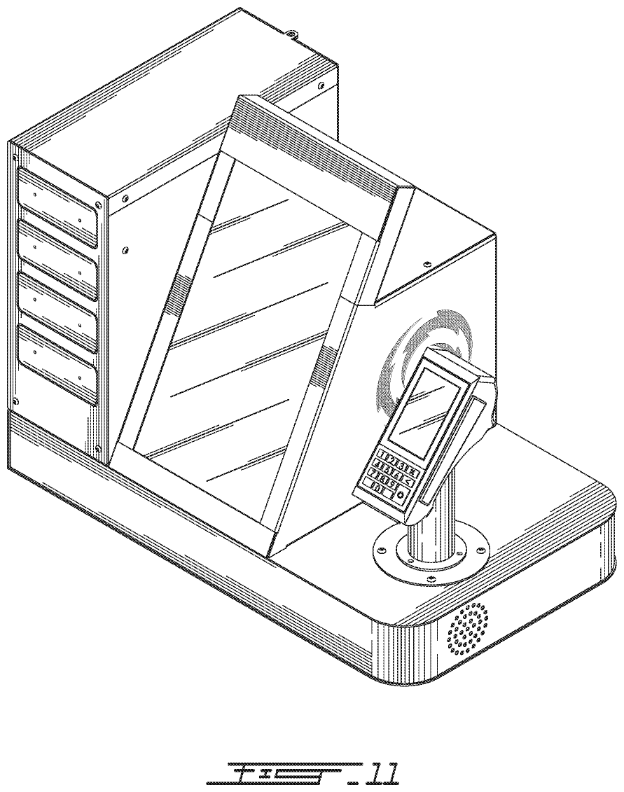

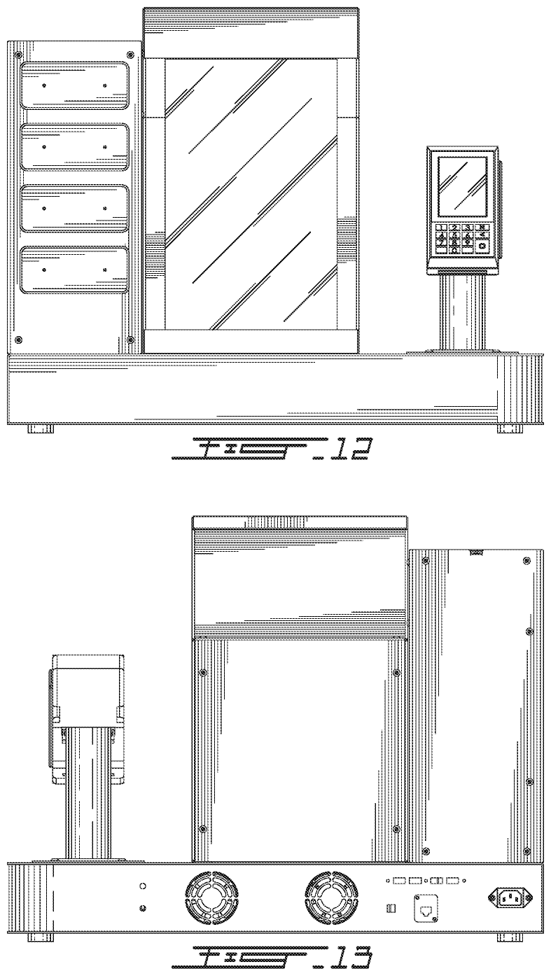

FIG. 11 shows another embodiment of a service kiosk 1500. This service kiosk may provide similar features as previous embodiments but is in a smaller form factor or desktop kiosk version. This embodiment of the smaller version of the service kiosk 1500 may fit on a desktop and may provide certain mobility advantages such as ease of transport, inside or outside locations and ease of delivery/removal for maintenance or repairs. The embodiment of the desktop kiosk shown in FIG. 11 may also be locked to prevent unauthorized removal and/or may, in some embodiments, contain GPS module in order to locate service kiosk remotely, for example, if the service kiosk is removed without authorization. FIG. 12 shows the front view of the desk-top kiosk version 1500. FIG. 13 shows the rear view of the desk-top kiosk version 1500. FIG. 13 also shows the antenna 1501, the USB HUB location 1505, the Network 1510 and power 1515.

A computer program product of the subject matter described herein comprises one or more computer readable hardware storage devices having computer readable program code stored therein, said program code containing instructions executable by one or more processors of a computer system to implement the methods of the present invention.

A computer program product of the subject matter described herein comprises one or more computer readable hardware storage devices having computer readable program code stored therein, said program code containing instructions executable by one or more processors of a computer system to implement the methods of the present invention.

A computer system of the subject matter described herein comprises one or more processors, one or more memories, and one or more computer readable hardware storage devices, said one or more hardware storage devices containing program code executable by the one or more processors via the one or more memories to implement the methods of the present invention.

The subject matter described herein may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a wave guide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the subject matter described herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the subject matter described herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the present disclosure describes various exemplary embodiments, the disclosure is not so limited. To the contrary, the disclosure is intended to cover various modifications and equivalent arrangements included within the general scope of the present disclosure.

1. A system for releasably storing keys, the keys providing access for a keyholder to a vehicle, the system comprising:
a multi-unit key storage facility comprising a plurality of independently accessible storage units, each said independently accessible storage unit configured to be unlocked independently of one another based on digital unlocking signals that trigger unit-specific lock mechanisms;
a communications bus for interfacing with a pre-existing independent third-party data storage facility, the third-party data storage facility comprising pre-existing service information relating to: the vehicle, a user thereof, or a combination thereof;
one or more user interface devices for receiving user-identifying information about users;
local digital data storage for storing locally-stored information relating to one or more of the following: user-identifying information and authorization information relating to each independently accessible storage unit;
a processor, being communicatively coupled to said local digital data storage, said communications bus, and said multi-unit storage facility, said processor configured determine whether a given user is authorized to access a given storage unit based on said user-identifying information and said authorization information, said processor further configured to transmit a digital unlocking signal to the given storage unit when the requesting user is determined by said processor to be authorized to access the given storage unit.

2. The system of claim 1, wherein the third-party data storage facility includes payment information.

3. The system of claim 1, wherein the system further includes an automatic payment receiver.

4. The system of claim 1, wherein the user interface device collects biometric information.

5. The system of claim 1, wherein the user interface device collects information from an NFC device issued to the user.

6. The system of claim 1, wherein the one or more user interface devices comprises a mobile phone communications interface.

7. The system of claim 1, wherein the processor is further configured to identify an entity-specific service offering from a pre-determined set of available entity services based on a combination of the pre-existing service information and the locally-stored information.

8-9. (canceled)

10. The system of claim 1, wherein the processor is configured to transmit directly to a computing device of the user.

11. The system of claim 1, wherein the unit-specific lock mechanisms are not accessible to a user.

12. The system of claim 1, wherein the storage units comprise a sliding drawer.

13. The system of claim 1, wherein the storage unit comprises a spring, self-aligning insertion means, a sensor to indicate the presence of material inside the unit.

14-17. (canceled)

18. A method for securely transferring keys for vehicles associated with remotely-stored independent third-party vehicle information, using a multi-unit key storage device with a plurality of independently accessible key storage units, each said key storage unit comprising a locking mechanism configured to be unlocked upon receipt of a digital unlocking signal, the method comprising the steps:
interfacing, via a communications bus, a pre-existing independent third-party data storage facility, and obtaining pre-existing vehicle-specific information, said vehicle-specific information comprising vehicle information, vehicle owner information, and vehicle service event information from said third-party data storage facility;
receiving, via one or more user interface devices, user-identifying information relating to a user, said user being one of the following: a vehicle owner associated with the given vehicle, a service-provider associated with the given vehicle;
allocating a key storage unit from the plurality thereof for storing a given vehicle-specific key associated with a given vehicle having vehicle information associated therewith stored in the data storage facility relating to one or more service events for said given vehicle;
transmitting the digital unlocking signal to the first key storage unit allocated for the vehicle-specific key upon receipt by the key storage device of user-identifying information associated with said vehicle-specific key, and one or more of the following from said third-party data storage facility: scheduling information associated with said given vehicle, completion information relating to said vehicle service event, payment information associated with said vehicle service event.

19. The method of claim 18 further comprising:
generating one or more vehicle-specific service options relating to the given vehicle based on vehicle-specific information for the given vehicle from said third-party data storage facility; and
presenting for selection, at approximately the same time as a transmission of the digital unlocking signal, said one or more vehicle-specific service options to the vehicle owner of the given vehicle via one of the one or more user interface devices.

20. The method of claim 19 further comprising:
transmitting selected vehicle-specific service options to said third-party data storage facility.

21. The method of claim 18, wherein one of the one or more user interface devices collects biometric information.

22. The method of claim 18, wherein one of the one or more user interface devices collects information from an NFC device issued to the user.

23. The method of claim 18, wherein one of the one or more user interface devices comprises a mobile phone communications interface.

24. The method of claim 18, wherein one of the one or more user interface devices is configured to further determine a proximity of the user, and wherein said transmitting of the digital unlocking signal is further based on said proximity.

25-30. (canceled)
